(19) United States
(12) Patent Application Publication
(10) Pub. No.: US 2026/0131969 A1
(43) Pub. Date: May 14, 2026

(54) MOVING A REFUSE LIFT ARM SYSTEM

(71) Applicant: The Heil Co., Chattanooga, TN (US)

(72) Inventors: Mark Fraas, Centre, AL (US); Ethan Lee Maness, Rainsville, AL (US); Kishornaik S, Bengaluru (IN)

(21) Appl. No.: 19/380,012

(22) Filed: Nov. 5, 2025

Related U.S. Application Data
(60) Provisional application No. 63/718,227, filed on Nov. 8, 2024.

(51) Int. Cl. B65F 3/02

(52) U.S. Cl. CPC B65F 3/02; B65F 2003/023

(57) ABSTRACT

A refuse collection vehicle having an arm assembly with a grabber to reposition a customer refuse container. The arm assembly has a base beam fixed to the refuse collection vehicle, an intermediate beam within the base beam, a grabber beam within the intermediate beam, an actuator coupled to the base beam and the intermediate beam, and a flexible tether which is fixed between the base beam and the grabber beam. The grabber is coupled to the grabber beam. In response to operation of the actuator, the flexible tether exerts a force on the intermediate beam to move the grabber beam between a retracted position and an extended position, repositioning the grabber.

### CROSS-REFERENCE TO RELATED APPLICATION

This application claims the benefit under 35 U.S.C. § 119(e) of U.S. Patent Application No. 63/718,227, entitled “Moving A Refuse Lift Arm System,” filed November 8, 2024, which is incorporated herein by reference in its entirety.

### TECHNICAL FIELD

This disclosure relates to the field of refuse collection vehicles.

### BACKGROUND

Refuse collection vehicles are typically used to pick up quantities of refuse (e.g., garbage, waste, recyclables, etc.) for hauling to a designated area, such as a landfill, transfer station, or material recovery facility. Some refuse collection vehicles include loading mechanisms to assist in loading refuse or other materials into the refuse collection vehicle.

### SUMMARY

Some implementations of this disclosure feature a refuse lift arm system for engaging a refuse container proximate to a refuse collection vehicle. In one example aspect, the refuse lift arm system is coupled to a refuse collection vehicle. The refuse collection vehicle has a vehicle chassis, a refuse collection body coupled to the vehicle chassis, and the refuse lift arm assembly is coupled to the vehicle chassis. The arm assembly has a grabber and an arm. The arm is coupled to the grabber. The arm has a base beam, an intermediate beam, a grabber beam, an actuator, an extension wheel, an extension tether, a retraction wheel, and a retraction tether. The intermediate beam is positioned within the base beam. The grabber beam is positioned within the intermediate beam. The actuator is coupled to the intermediate beam. The extension wheel coupled to an outer surface of the intermediate beam. The extension tether is supported by the extension wheel. The extension tether has a first end and a second end. The first end of the extension tether is coupled to an inner surface of the grabber beam and the second end of the extension tether is coupled to an outer surface of the base beam. The retraction wheel is coupled to the inner surface of the intermediate beam. The retraction tether is supported by the retraction wheel. The retraction tether has a first end and a second end. The first end of the retraction tether is coupled to the inner surface of the grabber beam and the second end of the retraction tether is coupled to the outer surface of the base beam.

In an example aspect combinable with any other aspect, operation of the actuator in a first direction extends the intermediate beam relative to the base beam. The extension tether transfers a first force from the intermediate beam to the grabber beam, rotating the extension wheel and thereby moving the grabber beam in the first direction, moving the grabber from a retracted position to an extended position. Operation of the actuator in a second direction opposite the first direction retracts the intermediate beam relative to the base beam. The retraction tether transfers a second force from the intermediate beam to the grabber beam, rotating the retraction wheel and thereby moving the grabber beam in the second direction, moving the grabber from the extended position to the retracted position.

In an example aspect combinable with any other aspect, the actuator is a single hydraulic cylinder.

In an example aspect combinable with any other aspect, a first pathway extends from a first location on the inner surface of the grabber beam, out a proximal end of the grabber beam, between the grabber beam and the intermediate beam, out a distal end of the intermediate beam, and around the extension wheel to a second location on the base beam. The extension tether is disposed along the first pathway. A second pathway extends from a third location on the inner surface of the grabber beam, out the proximal end of the grabber beam, through the intermediate beam to the retraction wheel, out the proximal end of the intermediate beam, between the intermediate beam and the base beam, out the distal end of the base beam, to a fourth location on the base beam. The retraction tether is disposed along the second pathway.

In an example aspect combinable with any other aspect, the arm assembly includes an extension guide block coupled to the proximal end of the grabber beam. The extension guide block receives the extension tether. The arm assembly includes a retraction guide block coupled to the distal end of the base beam. The retraction guide block receives the retraction tether.

In an example aspect combinable with any other aspect, the extension guide block and the retraction guide block reverse a direction of the extension tether and the retraction tether about the grabber beam and the base beam, respectively.

In an example aspect combinable with any other aspect, the extension guide block is positioned along the first pathway between the first location and the extension wheel. The retraction guide block is positioned along the second pathway between the fourth location and the retraction wheel.

In an example aspect combinable with any other aspect, the extension guide block defines an extension U-shaped channel to receive the extension tether. The retraction guide block defines a retraction U-shaped channel to receive the retraction tether.

In an example aspect combinable with any other aspect, the extension U-shaped channel and the retraction U-shaped channel are defined by an inner diameter between 0.70 inches and 0.90 inches.

In an example aspect combinable with any other aspect, a ratio of the inner diameter of the extension U-shaped channel and the retraction U-shaped channel to a diameter of the respective extension wheel and retraction wheel is between 7.4:1 and 7.9:1.

In an example aspect combinable with any other aspect, the extension U-shaped channel and the retraction U-shaped channel each have a trapezoidal cross-section.

In an example aspect combinable with any other aspect, the extension guide block is coupled to the inner and outer surfaces of the grabber beam and the retraction guide block is coupled to the inner and outer surfaces of the base beam.

In an example aspect combinable with any other aspect, the extension tether and the retraction tether are a wire rope.

In an example aspect combinable with any other aspect, the wire rope has a first loop at a first terminating end and a second loop at a second terminating end.

In an example aspect combinable with any other aspect, the extension tether and the retraction tether are a polymer belt.

In an example aspect combinable with any other aspect, the arm assembly includes a first bracket, a second bracket, a third bracket, and a fourth bracket. The first bracket is positioned on the inner surface of the grabber beam. The first end of the extension tether is coupled to the first bracket by a first pin. The second bracket is positioned on the outer surface of the base beam. The second end of the extension tether is coupled to the second bracket by a second pin. The third bracket is positioned on the inner surface of the grabber beam. The first end of the retraction tether is coupled to the third bracket by a third pin. The fourth bracket is positioned on the outer surface of the base beam. The second end of the retraction tether is coupled to the fourth bracket by a fourth pin.

In an example aspect combinable with any other aspect, the arm assembly includes a first roller support plate. The second bracket is coupled to the first roller support plate. The first roller support plate extends around the outer surface of the base beam.

In an example aspect combinable with any other aspect, a portion of the first roller support plate extends past a distal end of the base beam.

In an example aspect combinable with any other aspect, the arm assembly includes a first roller coupled to the portion of the first roller support plate extending past the distal end of the base beam. The first roller supports the intermediate beam.

In an example aspect combinable with any other aspect, the arm assembly includes a second roller support plate. The extension wheel is coupled to the second roller support plate. The second roller support plate extends around the outer surface of the intermediate beam.

In an example aspect combinable with any other aspect, a portion of the second roller support plate extends past the distal end of the intermediate beam.

In an example aspect combinable with any other aspect, the arm assembly includes a second roller is coupled to the portion of the second roller support plate and extends past the distal end of the intermediate beam. The second roller supports the grabber beam.

In an example aspect combinable with any other aspect, the arm assembly includes a first inner roller assembly and a second inner roller assembly. The first inner roller assembly has a first set of inner rollers. The first inner roller assembly is coupled to an inner surface of the intermediate beam and extends from a proximal end of the intermediate beam into the base beam. The first inner roller assembly supports the intermediate beam within the base beam. The second inner roller assembly includes a second set of inner rollers. The second inner roller assembly is coupled to the inner surface of the grabber beam and extends from the proximal end of the grabber beam into the intermediate beam. The second inner roller assembly supports the grabber beam within the intermediate beam.

In an example aspect combinable with any other aspect, the intermediate beam and the grabber beam are slidable relative to the base beam to move the grabber between the extended position and the retracted position.

In an example aspect combinable with any other aspect, the base beam is coupled to the vehicle chassis.

In an example aspect combinable with any other aspect, the grabber beam is coupled to the grabber.

In an example aspect combinable with any other aspect, the arm assembly includes a mast. The grabber rides in a vertical direction in the mast.

In an example aspect combinable with any other aspect, the arm assembly is sized so no actuator can be positioned within the base beam, the intermediate beam, and the grabber beam.

In another example aspect, an assembly includes a base beam, a grabber beam, an intermediate beam, and a flexible tether. The intermediate beam is between the base beam and grabber beams. The flexible tether is fixed between the base beam and the grabber beam. The flexible tether exerts a pushing force on the grabber beam in response to movement of the intermediate beam.

In an example aspect combinable with any other aspect, the flexible tether transfers the pushing force from the intermediate beam to the grabber beam without deforming linearly.

In an example aspect combinable with any other aspect, the assembly includes a linear actuator coupled to the base beam and the intermediate beam. The linear actuator can exert the pushing force on the intermediate beam.

In an example aspect combinable with any other aspect, the linear actuator includes at least one of an electric actuator or a hydraulic actuator.

In an example aspect combinable with any other aspect, the linear actuator is coupled to the base beam and the intermediate beam outside both the base beam and the intermediate beam.

In an example aspect combinable with any other aspect, no actuators are positioned within the base beam, the intermediate beam, and the grabber beam.

In an example aspect combinable with any other aspect, the assembly includes at least one roller coupled within one or more of the base beam, the intermediate beam, and the grabber beam to support another beam.

In an example aspect combinable with any other aspect, the assembly includes at least one roller coupled outside one or more of the base beam, the intermediate beam, and the grabber beam to support another beam.

In an example aspect combinable with any other aspect, at least one roller is positioned at a distal end of the respective beam.

In an example aspect combinable with any other aspect, the assembly includes a wheel coupled to the intermediate beam. The wheel is rotatable by the flexible tether responsive to the pushing force applied to the intermediate beam.

In an example aspect combinable with any other aspect, a diameter of the wheel is between four and six inches.

In an example aspect combinable with any other aspect, the wheel changes a direction of the pushing force of the flexible tether.

In an example aspect combinable with any other aspect, a mechanical advantage of the wheel is between 7.4:1 to 7.9:1.

In an example aspect combinable with any other aspect, a magnitude of the pushing force corresponds to a characteristic of the assembly.

In an example aspect combinable with any other aspect, the characteristic is a diameter.

In an example aspect combinable with any other aspect, the assembly includes a guide block defining a channel to receive the flexible tether.

In an example aspect combinable with any other aspect, the guide block changes a direction of the flexible tether about one or more of the beams.

In an example aspect combinable with any other aspect, the guide block directs the flexible tether around the end of at least one of the beams.

In an example aspect combinable with any other aspect, the guide block directs the flexible tether from inside to outside of at least one of the beams.

In an example aspect combinable with any other aspect, the guide block transfers the pushing force to the grabber beam.

In an example aspect combinable with any other aspect, the guide block transfers the pushing force to the grabber beam in a direction of the force.

In an example aspect combinable with any other aspect, the guide block changes a direction of the pushing force.

In another example aspect, an assembly has multiple beams, an extension tether, and a retraction tether. The extension tether extends between the beams and transfers an extension force from one beam to another beam. The retraction tether extends between the beams and transfers a retraction force from the one beam to another beam. The retraction force is directed opposite the extension force.

In an example aspect combinable with any other aspect, each of the beams are arranged concentrically.

In an example aspect combinable with any other aspect, transfer of the extension force from the one beam to another beam extends the other beam in a first direction. Transfer of the retraction force from the one beam to another beam retracts the other beam relative to the one beam in a second direction opposite the first direction.

In an example aspect combinable with any other aspect, the assembly includes one wheel for extension moving one or more of the beams in the first direction.

In an example aspect combinable with any other aspect, the assembly includes a retraction wheel for extension moving one or more of the beams in the second direction.

In another example aspect, a refuse collection vehicle includes a vehicle chassis, a refuse collection body coupled to the vehicle chassis; and an arm assembly coupled to the vehicle chassis. The arm assembly includes a grabber and an arm. The arm is coupled to the grabber. The arm includes a base beam, an intermediate beam, a grabber beam, an actuator, a first set of wheels, a first tether, a second set of wheels, and a second tether. The intermediate beam is within the base beam. The grabber beam is within the intermediate beam. The actuator is coupled to the intermediate beam. The first tether is supported by the first set of wheels. The first tether has a first end and a second end. The first end of the first tether terminates on the grabber beam at a first location. The second end of the first tether terminates on the grabber beam at a second location. The second tether is support by the second set of wheels. The second tether has a first end and a second end. The first end of the second tether terminates on the grabber beam at a third location. The second end of the second tether terminates on the grabber beam at a fourth location.

In an example aspect combinable with any other aspect, the first set of wheels and the second set of wheels are mounted within an internal volume of the arm assembly.

In an example aspect combinable with any other aspect, operation of the actuator in a first direction extends the intermediate beam relative to the base beam. The first tether transfers a first force from the intermediate beam to the grabber beam, rotating the first set of wheels and thereby moving the grabber beam in the first direction, and moving the grabber from a retracted position to an extended position. Operation of the actuator in a second direction opposite the first direction retracts the intermediate beam relative to the base beam. The first tether transfers a second force from the intermediate beam to the grabber beam, rotating the first set of wheels and thereby moving the grabber beam in the second direction, and moving the grabber from the extended position to the retracted position.

In an example aspect combinable with any other aspect, the first end of the first tether terminates at the first location on an inner surface of the grabber beam and the second end of the first tether terminates at the second location on an outer surface of the grabber beam. The first end of the second tether terminates at the third location on the inner surface of the grabber beam and the second end of the second tether terminates at the fourth location on the outer surface of the grabber beam.

In an example aspect combinable with any other aspect, the first set of wheels includes a first wheel, a second wheel, a third wheel, and a fourth wheel. The first wheel is coupled to an inner surface of the base beam. The first wheel is coupled to a proximal end of the base beam. The first wheel is oriented vertically in the arm. The second wheel is coupled to the inner surface of the base beam. The second wheel is coupled to a distal end of the base beam. The second extension wheel is oriented horizontally in the arm. The third wheel is coupled to a proximal end of the intermediate beam. The third wheel is oriented vertically in the arm. The fourth wheel is coupled at the proximal end of the intermediate beam. The fourth wheel is oriented vertically in the arm. The fifth wheel is coupled to a distal end of the intermediate beam. The fifth wheel is oriented horizontally in the arm. The second set of wheels includes a first wheel, a second wheel, a third wheel, a fourth wheel, and a fifth wheel. The first wheel of the second set is coupled to an inner surface of the base beam. The first wheel of the second set is coupled to the distal end of the base beam. The first wheel of the second set is oriented vertically in the arm. The second wheel of the second set is coupled to the inner surface of the base beam. The second wheel of the second set is coupled to the distal end of the base beam. The second wheel of the second set is oriented horizontally in the arm. The third wheel of the second set is coupled to the proximal end of the intermediate beam. The third wheel of the second set is oriented vertically in the arm. The fourth wheel of the second set is coupled at the proximal end of the intermediate beam. The fourth wheel of the second set is oriented vertically in the arm. The fifth wheel is coupled to the distal end of the intermediate beam. The fifth wheel of the second set is oriented horizontally in the arm.

In an example aspect combinable with any other aspect, a first pathway extends from the first location on an inner surface of the grabber beam, out a proximal end of the grabber beam, out a proximal end of the intermediate beam, to the first wheel of the first set of wheels, and around the first wheel of the first set of wheels between the base beam and the intermediate beam toward the distal end of the base beam to the second wheel of the first set of wheels, around the second wheel of the first set of wheels reversing direction toward the proximal end of the intermediate beam to the third wheel of the first set of wheels, around the third wheel of the first set of wheels to the fourth wheel of the first set of wheels, about the fourth wheel of the first set of wheels toward the distal end of the intermediate beam, in between the intermediate beam and the grabber beam to the fifth wheel of the first set of wheels, around the fifth wheel of the first set of wheels, reversing direction toward the proximal end of the grabber arm to the second location on the grabber beam. The first tether is disposed along the first pathway. A second pathway extends from the third location on the inner surface of the grabber beam, out the proximal end of the grabber beam, through the intermediate beam, out the proximal end of the intermediate beam, to the first wheel of the second set of wheels, around the first wheel of the second set of wheels reversing direction toward the distal end of the base beam, between the intermediate beam and the base beam to the second wheel of the second set of wheels, around the second wheel of the second set of wheels reversing direction toward the proximal end of the intermediate beam to the third wheel of the second set of wheels, around the third wheel of the second set of wheels to the fourth wheel of the second set of wheels, about the fourth wheel of the second set of wheels toward the distal end of the intermediate beam, in between the intermediate beam and the grabber beam to the fifth wheel of the second set of wheels, around the fifth wheel of the second set of wheels, reversing direction toward the proximal end of the grabber arm to the fourth location on the grabber beam. The second tether is disposed along the second pathway.

In an example aspect combinable with any other aspect, the fourth wheel of the first set of wheels and the fourth wheel of the second set of wheels alters a height of the respective tether.

In an example aspect combinable with any other aspect, the height of the respective tether is altered in a vertical direction.

In an example aspect combinable with any other aspect, a diameter of each of the fourth wheel of the first set of wheels and the fourth wheel of the second set of wheels is less than a diameter of each of the third wheel of the first set of wheels and the third wheel of the second set of wheels, respectively.

In an example aspect combinable with any other aspect, a center of each of the fourth wheel of the first set of wheels and the fourth wheel of the second set of wheels is offset vertically from a center of each of the third wheel of the first set of wheels and the third wheel of the second set of wheels.

In an example aspect combinable with any other aspect, the actuator is a single hydraulic cylinder.

In an example aspect combinable with any other aspect, the actuator is positioned within an internal volume of the arm assembly.

In an example aspect combinable with any other aspect, the actuator is positioned outside an internal volume of the arm assembly.

In an example aspect combinable with any other aspect, the arm assembly includes a first tensioner positioned at the first location and a second tensioner positioned at the third location. The first ends of the first tether and the second tether are coupled to the first tensioner and the second tensioner, respectively.

In an example aspect combinable with any other aspect, the first tensioner and the second tensioner each include a guide block coupled to the tether, a frame, a bolt extended through the frame to the guide block, and a spring positioned between the bolt and the frame.

In an example aspect combinable with any other aspect, the arm assembly includes a first roller assembly, a second roller assembly, a third roller assembly, and a fourth roller assembly. The first roller assembly is mounted to a proximal end of the intermediate beam and extends internal to the arm from the intermediate beam into the base beam. The second roller assembly is mounted to the proximal end of the grabber beam and extends internal to the arm from the grabber beam into the intermediate beam. The third roller assembly is mounted to a distal end of the base beam and extends external to the arm from the base beam to contact the intermediate beam. The fourth roller assembly is mounted to the distal end of the intermediate beam and extends external to the arm from the intermediate beam to contact the grabber beam.

In an example aspect combinable with any other aspect, the intermediate beam and the grabber beam slide relative to the base beam to move the grabber between an extended position and a retracted position.

Particular implementations of the subject matter described in this specification can be implemented so as to realize one or more material advantages. For example, certain implementations provide a refuse lift arm system that is inexpensive to manufacture and maintain, occupies a compact volume envelope, is energy efficient, and is relatively easy to service (e.g., by repairing and replacing worn components). For example, less energy may be used to actuate the arm assembly because of the increased mechanical advantage of the arm assembly. For example, the cycle time to operate the arm assembly between a retracted position and the extended position can be decreased. For example, heavier loads can be moved by the arm assembly for the same amount of energy consumed compared to a conventional arm assembly.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a refuse collection vehicle featuring a refuse lift arm system.

FIG. 2 is a perspective view of a refuse lift arm system with an arm in the retracted position.

FIG. 3 is a perspective view of a refuse lift arm system with the arm of FIG. 2 in the extended position.

FIG. 4 is another perspective view of the arm of FIG. 2 in the retracted position.

FIG. 5 is a cross-section view of the arm of FIG. 2 in the retracted position.

FIG. 6 is another perspective view of the arm of FIG. 2 with the arm in the extended position top view of a rail assembly of a container lift.

FIG. 7 is a cross-section view of the arm of FIG. 2 in the extended.

FIG. 8 is a perspective view of a guide block of the arm of FIG. 2.

FIG. 9 is a cross-section view of the guide block of FIG. 8.

FIG. 10 is a perspective view of the guide block of FIG. 8.

FIG. 11 is a cross-section perspective of the arm of FIG. 2 in the extended position.

FIG. 12 is a cross-section side view of another refuse lift arm system with the arm in a retracted position.

FIG. 13 is a cross-section side view of the refuse lift arm system of FIG. 12 with the arm in an extended position.

FIG. 14 is a diagram of the arm of FIG. 12 moving from the retracted position to the extended position.

FIG. 15 is a diagram of the arm of FIG. 12 moving from the extend position to the retracted position.

FIG. 16 is a perspective view of the refuse lift arm system of FIG. 12 with the arm in a retracted position.

FIG. 17 is another perspective view of the refuse lift arm system of FIG. 12 with the arm in a retracted position.

FIG. 18 is a front perspective view of the refuse lift arm system of FIG. 12.

FIG. 19 is a rear view of the refuse lift arm system of FIG. 12.

FIG. 20 is a rear perspective view of the refuse lift arm system of FIG. 12.

FIG. 21 is another perspective view of the refuse lift arm system of FIG. 12.

FIG. 22 is a perspective view of another guide block of the arm of FIG. 2.

FIG. 23 is a cross-section view of the guide block of FIG. 22.

FIG. 24 is another diagram of the arm of FIG. 12 moving from the extended position to the retracted position.

### DETAILED DESCRIPTION

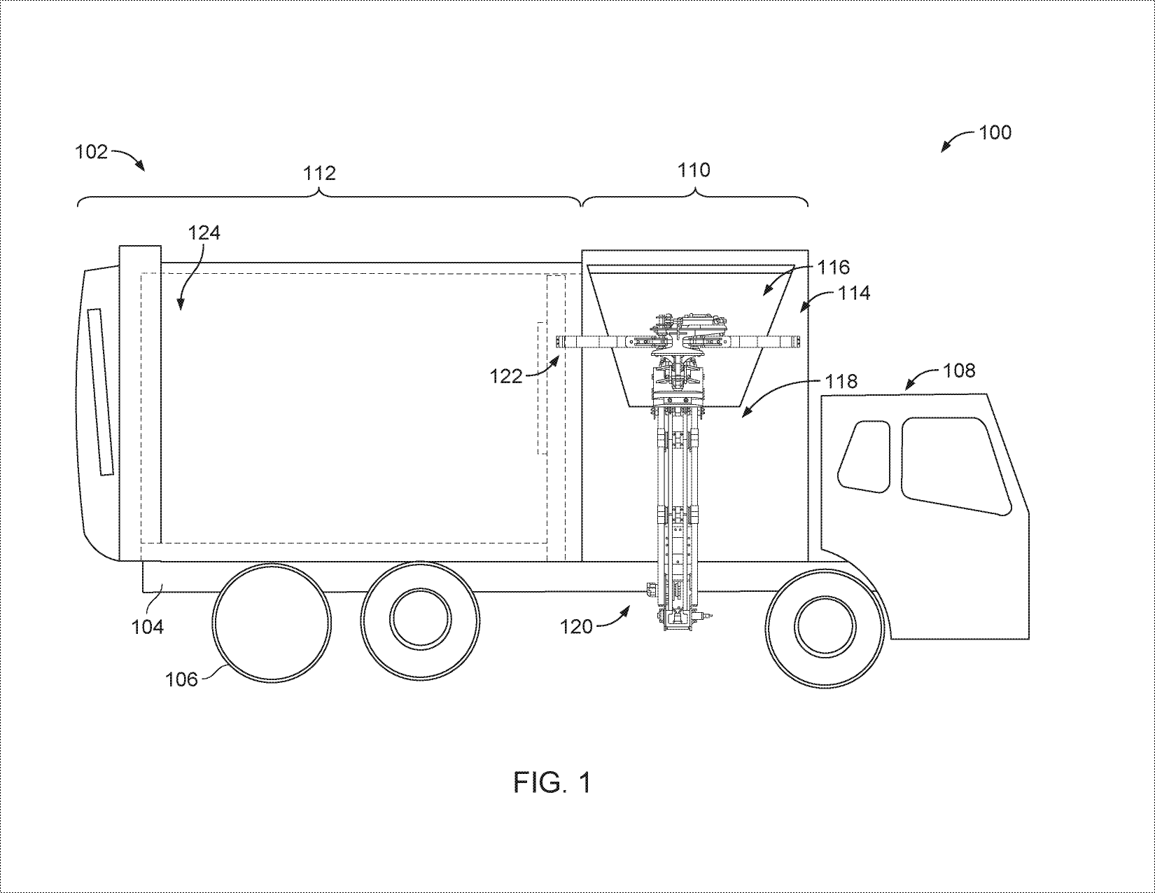

FIG. 1 illustrates a refuse collection vehicle 100. The refuse collection vehicle 100 is operable to collect, optionally pack, and transport refuse to a designated area, such as a landfill, transfer station, or material recovery facility.

The refuse collection vehicle 100 includes a waste collection device 102, a frame 104, wheels 106, and a cab 108. The waste collection device 102 includes a waste intake portion 110 and a waste storage portion 112. The waste intake portion 110 includes a refuse loading system 114 and a hopper 116. The refuse loading system 114 is operable to transfer the contents of refuse containers into the waste storage portion 112 via the hopper 116. In some implementations, the waste collection device 102 further includes a packer (not shown) operable to pack refuse loaded into the hopper 116, push refuse toward the rear of the refuse collection vehicle 100 (e.g., to the waste storage portion 112), and/or eject the refuse from the refuse collection vehicle 100.

The waste storage portion 112 includes a waste storage container 124. The waste storage container receives the refuse from the hopper 116.

The refuse loading system 114 includes a refuse lift arm system 118. The refuse lift arm system 118 includes a container lift 120 and a grabber assembly 122. The grabber assembly 122 is operable to engage (e.g., grasp) a refuse container located proximate the refuse collection vehicle 100. The container lift 120 is operable to lift the refuse container and to tip and dump the contents of the refuse container into the hopper 116.

In some implementations, the refuse collection vehicle 100 is an all-electric vehicle or an at least partially electric vehicle. For example, one or more (e.g., all) motive power elements, body controls, and sub-systems of refuse collection vehicle 100 (including refuse loading system 114, a packing system, an ejector system, a contamination detection system) can be electrically powered by onboard battery packs.

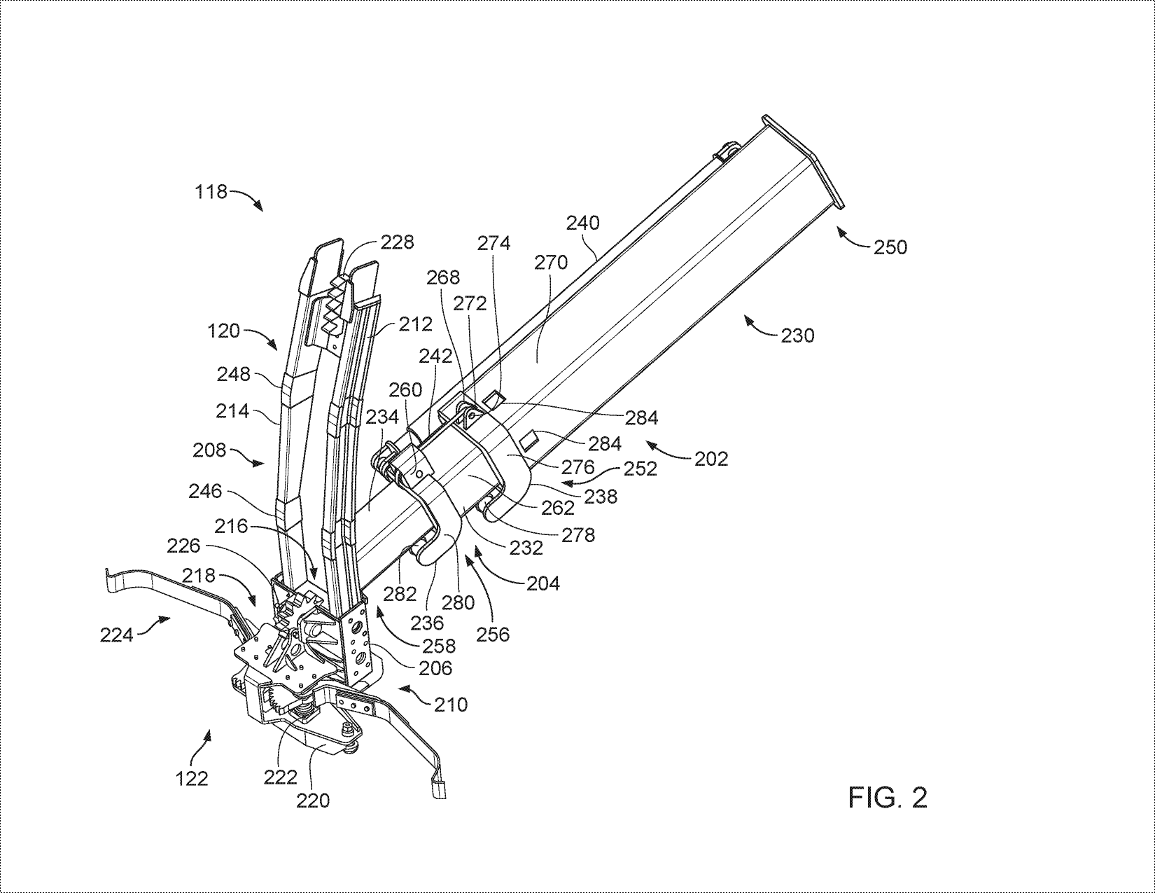

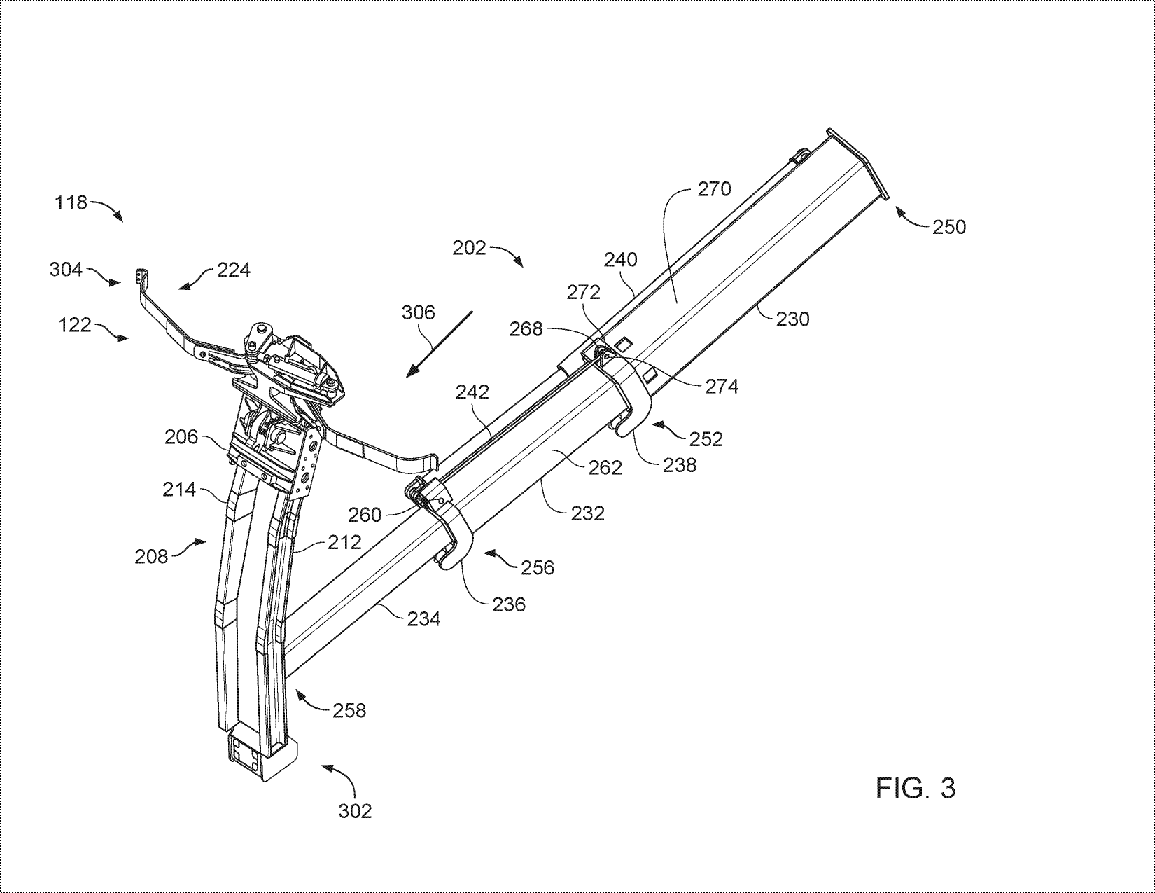

As shown in FIG. 2, the refuse lift arm system 118 includes the grabber assembly 122, the container lift 120, and an arm assembly 202. The arm assembly 202 horizontally positions the container lift 120 and the grabber assembly 122 relative to the refuse collection vehicle 100. The refuse lift arm system 118 is operable to engage a customer refuse container, to lift the customer refuse container, and to tip and empty the contents of the customer refuse container into a bin or the hopper 116 of the refuse collection vehicle 100 to which refuse lift arm system 118 is attached. As shown in FIG. 2, the arm assembly 202 is in a retracted position 204. FIG. 3 illustrates the refuse lift arm system 118 with the grabber assembly 122 in a raised and tipped condition. While the arms 224 of grabber assembly 122 are open in FIG. 3, in operation, the arms 224 could be closed to engage a refuse container. As shown in FIG. 3, the arm assembly 202 is in an extended position 302. Referring to FIGS. 2 and 3, the arm assembly 202 moves the grabber assembly 122 from the retracted position 204 closer to the refuse collection vehicle 100 to the extended position 302 to position the grabber assembly 122 to engage the customer refuse container. The arm assembly 202 moves the grabber assembly 122 from the extended position 302 farther away from the refuse collection vehicle 100 to the retracted position 204 to move the customer refuse container close to the refuse collection vehicle 100 so the container lift 120 can vertically reposition the customer refuse container off the ground and deposit the refuse contained within the customer refuse container into the hopper 116.

The container lift 120 includes a carriage 206, a rail assembly 208, a lift drive mechanism 216, and a tipping mechanism 218. The carriage 206 is coupled to the grabber assembly 122. The carriage 206 is also coupled to the rail assembly 208 and operable to translate (e.g., move up and down) along the extent of the rail assembly 208 between a raised position 304 (shown in FIG. 3) and a lowered position 210 (shown in FIG. 2). In this example, the rail assembly 208 includes left and right rails 212, 214. The carriage 206 includes rollers that engage the left rail 212 and right rail 214 of the rail assembly 208 to facilitate the translating movement of the carriage 206.

The lift drive mechanism 216 resides (at least partially) between the left and right rails 212, 214 of the rail assembly 208. The lift drive mechanism 216 is operable to drive the carriage 206, and thus the grabber assembly 122, to move along rail assembly 208 via the engaged rollers and left and right rails 212, 214. In some implementations, the lift drive mechanism 216 includes an electric motor. In some implementations, the lift drive mechanism 216 includes a hydraulic actuator. In some implementations, the lift drive mechanism 216 includes a linear actuator.

Any other kind of container lift may be used with the arm assembly 202 and the grabber assembly 122. For example, other container lifts are within the scope of this disclosure, including U.S. Patent Application Publication No. 2021/0122568, U.S. Patent Application Publication No. 2023/0090272, and U.S. Provisional Application No. 63/598,020 which are incorporated herein by reference.

The grabber assembly 122 is pivotally coupled to the carriage 206. As discussed further below, the grabber assembly 122 is supported and carried by the carriage 206, and the grabber assembly 122 can also rotate about a pivot axis relative to the carriage 206. The grabber assembly 122 includes a body 220, a grabber drive mechanism 222, and the arms 224. The grabber drive mechanism 222 is operable to open and close arms 224 to engage and hold the customer refuse container. In some implementations, the grabber drive mechanism 222 includes an electric motor. In some implementations, the grabber drive mechanism 222 includes a hydraulic actuator.

During a lift cycle, when the grabber assembly 122 is raised near the top of the rail assembly 208, the grabber assembly 122 pivots on the carriage 206 such that the customer refuse container held by the grabber assembly 122 is tipped. With the customer refuse container tipped, the contents of the customer refuse container are emptied into the hopper 116 or the waste storage portion 112 of the refuse collection vehicle 100.

The tipping mechanism 218 includes a pivot gear 226 and a rack 228. The pivot gear 226 is fixed to the grabber assembly 122 and rotatably mounted to the carriage 206. The rack 228 is fixed at a position near the top of the rail assembly 208 between the left and right rails 212, 214. During a lift cycle (referenced above), the carriage 206 translates upward on the rail assembly 208 while carrying the grabber assembly 122 and the pivot gear 226, causing the pivot gear 226 to engage the rack 228. The engagement between the pivot gear 226 and the rack 228 combined with the upward movement of the carriage 206 causes the grabber assembly 122 (and thus the customer refuse container held by the grabber assembly 122) to tip toward the hopper 116 or the waste storage portion 112 of the refuse collection vehicle 100.

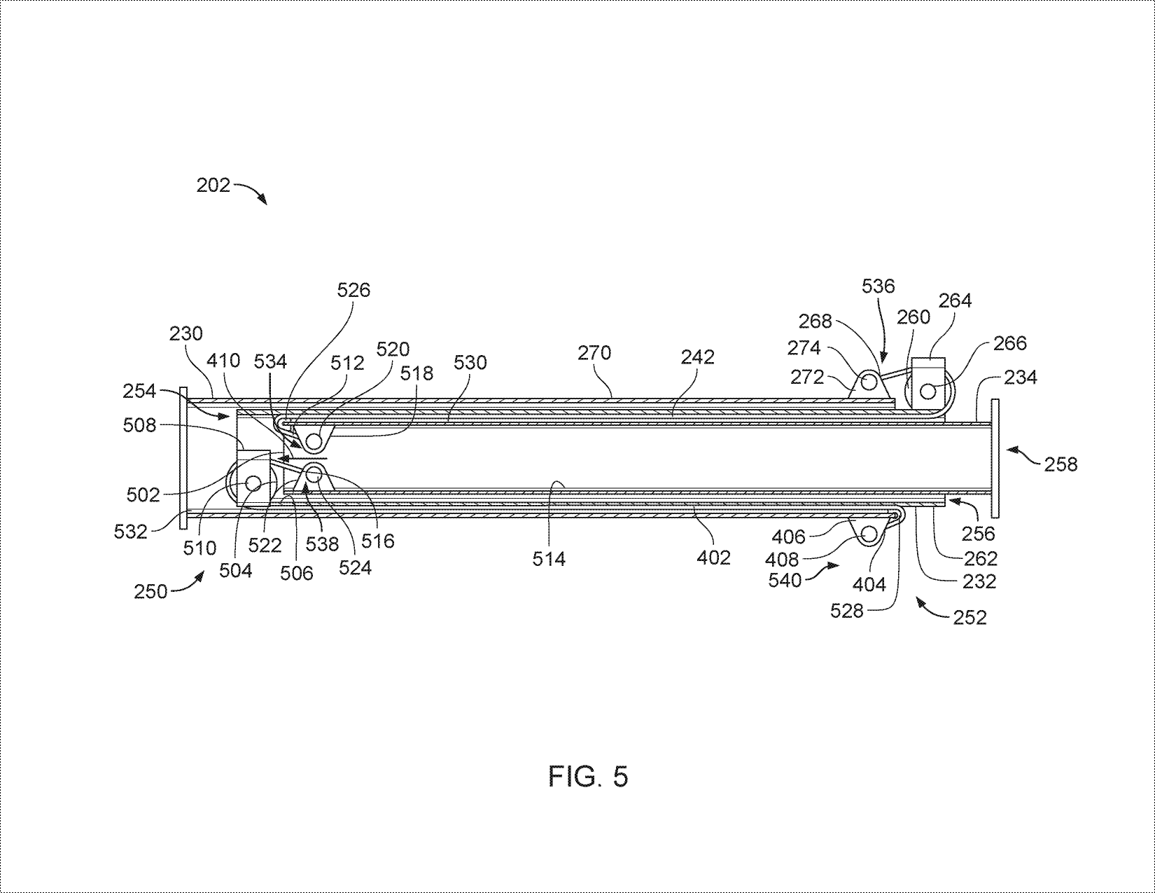

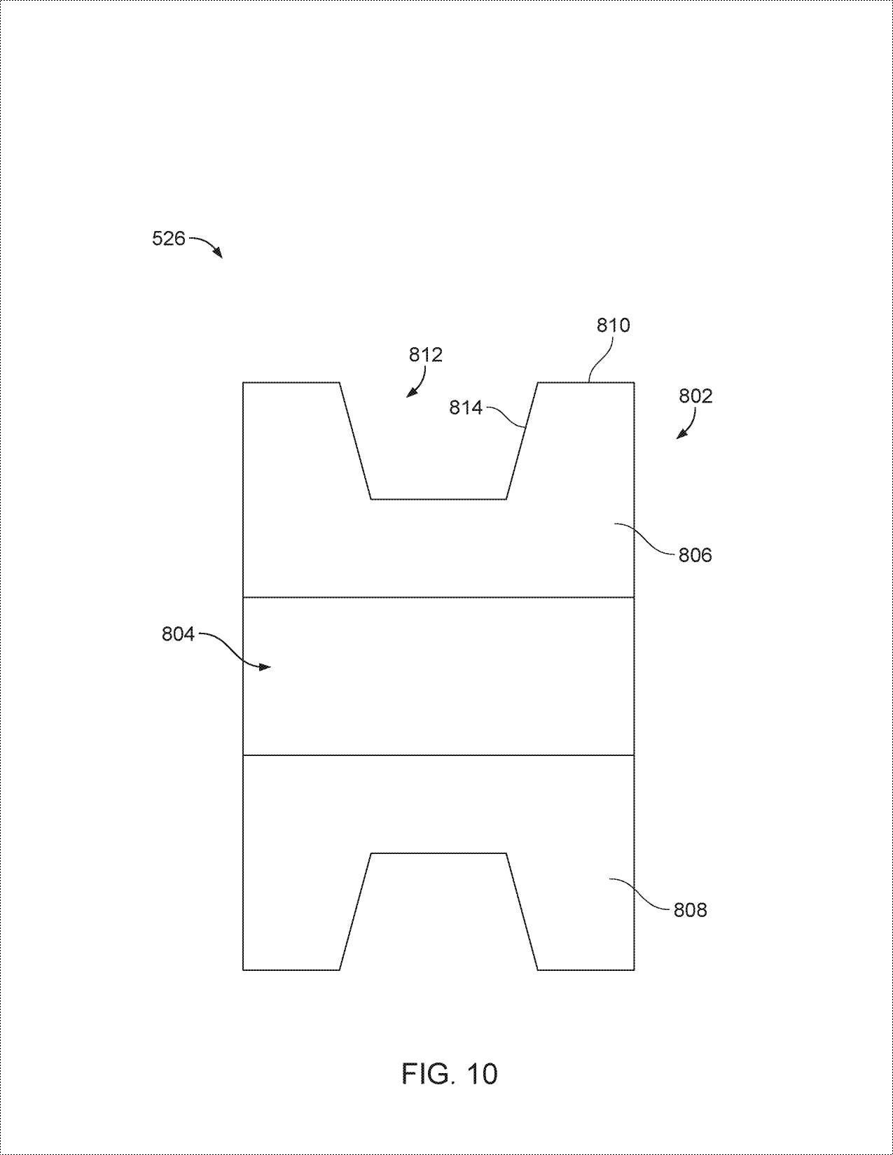

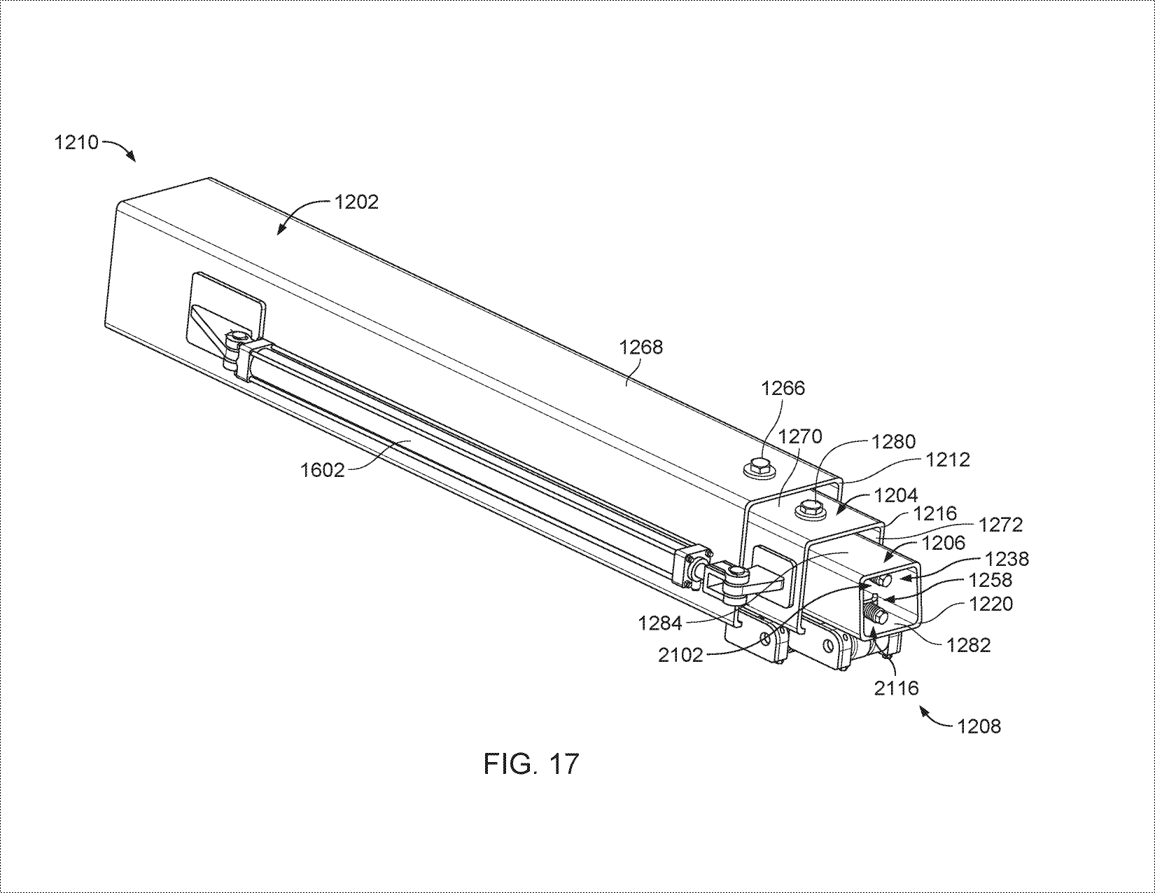

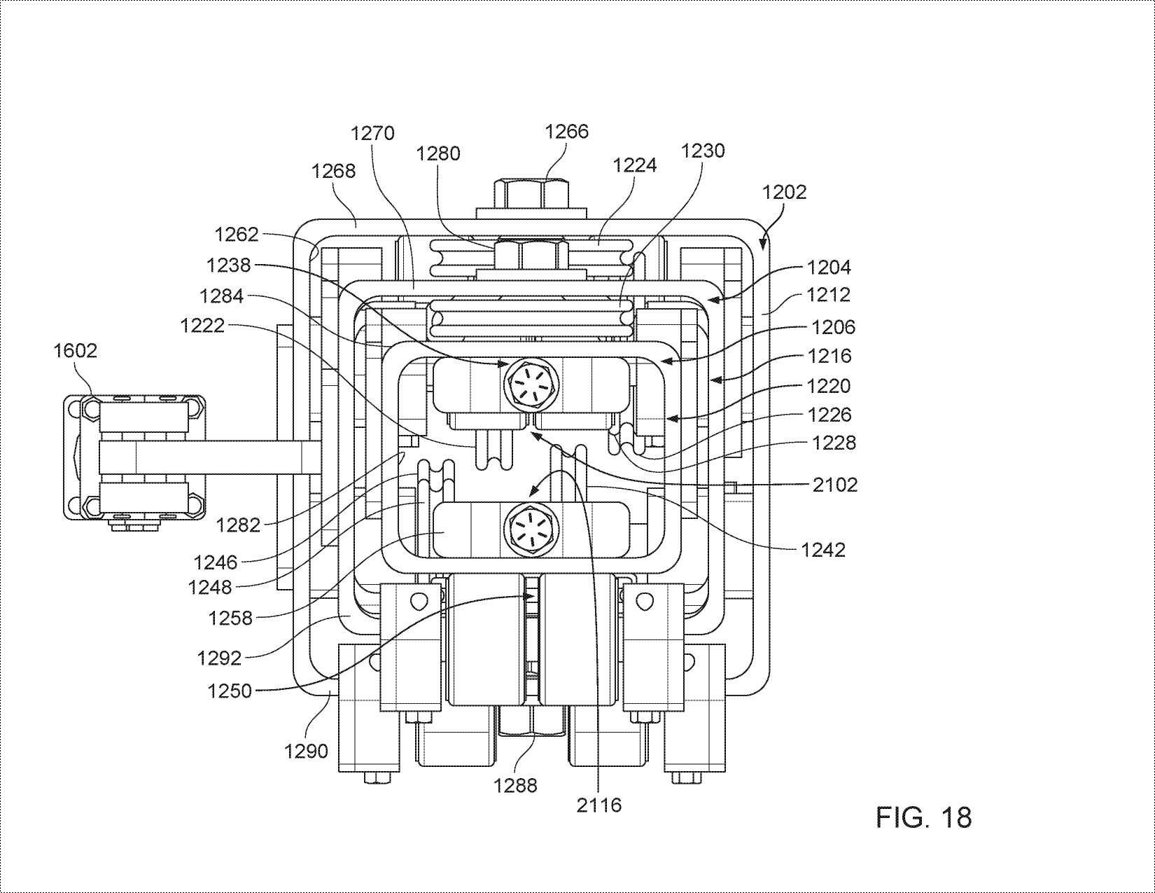

The rail assembly 208 is coupled to the refuse collection vehicle 100 by the arm assembly 202. The arm assembly 202 includes multiple telescoping sections (described in more detail in reference to FIGS. 2-20) that move the container lift 120 and the grabber assembly 122 toward or away from the refuse collection vehicle 100. As shown in FIG. 2, the arm assembly 202 includes three telescoping sections, including a base beam 230, an intermediate beam 232, and a grabber beam 234. The base beam 230 is secured to the refuse collection vehicle 100. The grabber beam 234 is secured to the container lift 120. The intermediate beam 232 couples the base beam 230 to the grabber beam 234. The arm assembly 202 has first and second external roller assemblies 236, 238, internal roller assemblies 1102, 1104 (described in reference to FIGS. 5, 7, and 11), a drive mechanism 240, and a tether 242 to facilitate relative movement between the telescoping sections (the base beam 230, the intermediate beam 232, and the grabber beam 234). The base beam 230, the intermediate beam 232, and the grabber beam 234 are arranged generally concentrically, with the grabber beam 234 generally concentrically internal to the intermediate beam 232 and the base beam 230, and the intermediate beam 232 generally concentrically internal to the base beam 230.

In this implementation, the arm assembly 202 is sized so no drive mechanism 240 is contained within the arm assembly 202. That is, each of the base beam 230, the intermediate beam 232, and the grabber beam 234 are too small for an actuator to be placed inside the arm assembly 202. However, in other implementations, at least the base beam 230 and the intermediate beam 232 are sized to allow placement of the drive mechanism 240 within the inner volume of the arm assembly 202.

The base beam 230 has cutouts 284. The cutouts 284 can be used to place wearing pads or allow rollers to extend from the sides of the base beam 230. In some implementations, the cutouts 284 can allow a user to access interior portions of the base beam 230 for servicing or maintenance. For example, the user can place grease within the base beam 230.

The drive mechanism 240 imparts motion (e.g., provides sufficient motive force and torque) to extend and retract the base beam 230, the intermediate beam 232, and the grabber beam 234, such that the container lift 120 and the grabber assembly 122 are moved toward or away from the refuse collection vehicle 100. In some implementations, the drive mechanism 240 is a single drive mechanism which drives the motion of both intermediate beam 232 and the grabber beam 234 relative to base beam 230. The drive mechanism 240 is coupled to the base beam 230 and the intermediate beam 232. In some implementations, the drive mechanism 240 includes one or more electric motors. In some implementations, the drive mechanism 240 includes one or more hydraulic actuators. In some implementations, the drive mechanism 240 includes one or more linear actuators.

The arm assembly 202 includes the extension tether 242 extending between the base beam 230, the intermediate beam 232, and the grabber beam 234 about a set of pulleys (described in more detail below). The extension tether 242 is a fixed length. Moving the intermediate beam 232 by the drive mechanism 240 extends the grabber beam 234 from the retracted position 204 to the extended position 302 and retracts the grabber beam 234 from the extended position 302 and the retracted position 204. In some implementations, the tether 242 is a wire rope. In some implementations, the tether 242 is a polymer belt.

The lift drive mechanism 216 of container lift 120 includes a left timing belt system, a right timing belt system, and the lift drive mechanism 216. The left timing belt system and the right timing belt system each include an upper timing pulley and a lower timing pulley rotatably coupled to rail assembly 208. A respective timing belt is arranged in a loop on each of the pairs of timing pulleys. The carriage 206 is attached to each of the respective timing belts. The lift drive mechanism 216 is coupled to drive the rotation of each of the lower pulleys of left timing belt system and right timing belt system. Rotation of the lower pulleys causes timing belts to move (e.g., sliding movement along low-friction pads), which drives translation of the carriage 206 along the rail assembly 208.

As shown in FIGS. 2-3, rail assembly 208 includes two lateral bends 246, 248 along its length. In some implementations, the lateral bends 246, 248 have a tilt angle relative to a vertical plane of between 2 and 17 degrees, such as between 5 and 12 degrees, and/or about 10 degrees. The term “about” in this disclosure, when used to describe a numerical range or value, references a margin within ± 5% of the stated value or range. In some implementations, the lateral bends 246, 248 have a substantially similar (e.g., within ± 5%) tilt angle. In some implementations, one of lateral bends 246, 248 has a larger tilt angle than the other lateral bend. In some implementations, the rail assembly can include no lateral bends, only one lateral bend, or more than two lateral bends.

In this example, the tilt angle of each of the lateral bends 246, 248 is in the same angular direction, such that the top portion of the rail assembly 208 extends laterally from the lower portion of the rail assembly 208, closer to the refuse collection vehicle 100. Accordingly, the lateral bends 246, 248 allow the grabber assembly 122 to position the customer refuse container closer to the hopper 116 or storage container of the refuse collection vehicle 100 when tipped. That is, during a dump cycle, as the carriage 206 moves upward along rail assembly 208 along with the grabber assembly 122 and the customer refuse container, all three objects move laterally closer to the refuse collection vehicle 100. This way, when the grabber assembly 122 and the customer refuse container are tipped, they are properly positioned over the hopper 116 or the storage container.

As shown in FIGS. 2 and 3, the lift drive mechanism 216 includes the left timing belt system, the right timing belt system, and the lift drive mechanism 216. The lift drive mechanism 216 further includes a drive sprocket, a driven sprocket , and a drive chain between them. The lift drive mechanism 216 includes an electric motor. The driven sprocket and the lower timing pulleys of the left timing belt system and the right timing belt system are coupled to a common shaft. The drive unit is operable to rotate the lower timing pulleys to raise and lower the carriage 206 on the rail assembly 208. An encoder is coupled to a shaft and communicatively coupled to a controller. An encoder can provide information to the controller about the position of the carriage 206 on the rail assembly 208 based on the detected position of the shaft.

In some implementations, a controller is operably coupled to the lift drive mechanism 216, the grabber drive mechanism 222, the drive mechanism 240, or any combination thereof. The controller can be operated to control the position of grabber assembly 122, as well as the open and/closure state of its arms 224.

The arm assembly 202 includes three sections, including the base beam 230, the intermediate beam 232, and the grabber beam 234. The arm assembly 202 also includes the first and second external roller assemblies 236, 238, the first and second internal roller assemblies 1102, 1104, and the drive mechanism 240. The drive mechanism 240 imparts motion (e.g., provides sufficient motive force and torque) to extend and retract the telescoping sections of the base beam 230, the intermediate beam 232, and the grabber beam 234, such that the container lift 120 and the grabber assembly 122 are moved toward or away from the refuse collection vehicle 100.

Referring to FIGS. 2-7 and 11, each of the base beam 230, the intermediate beam 232, and the grabber beam 234 have a proximal end and a distal end. The proximal ends are closer to the refuse collection vehicle 100 than the respective distal ends. The distal ends are farther from the refuse collection vehicle 100 than the respective proximal ends and closer to the grabber assembly 122.

The base beam 230 has a proximal end 250 and a distal end 252. The proximal end 250 of the base beam 230 is coupled to the body of the refuse collection vehicle 100. The proximal end 250 of the base beam 230 can be coupled to the frame 104. The second external roller assembly 238 is coupled to the distal end 252 of the base beam 230. The distal end 252 of the base beam 230 is open to receive the intermediate beam 232. The intermediate beam 232 slides within the base beam 230.

The intermediate beam 232 has a proximal end 254 and a distal end 256. The proximal end 254 of the intermediate beam 232 remains within the base beam 230 when the arm assembly 202 is actuated between the retracted position 204 and the extended position 302 as shown in FIGS. 3, 5-7, and FIG. 11. The distal end 256 of the intermediate beam 232 extends externally to the base beam 230. The first external roller assembly 236 is coupled to the distal end 256 of the intermediate beam 232. The distal end 256 of the intermediate beam 232 is open to allow the grabber beam 234 to move within the intermediate beam 232.

The grabber beam 234 has a proximal end 502, shown in FIGS. 5, 7, and 11, and a distal end 258, shown in FIGS. 2-7. The proximal end 502 of the grabber beam 234 remains within the intermediate beam 232 when the arm assembly 202 is actuated between the retracted position 204 and the extended position 302 as shown in FIGS. 3, 5-7, and FIG. 11. The distal end 258 of the grabber beam 234 is coupled to the container lift 120.

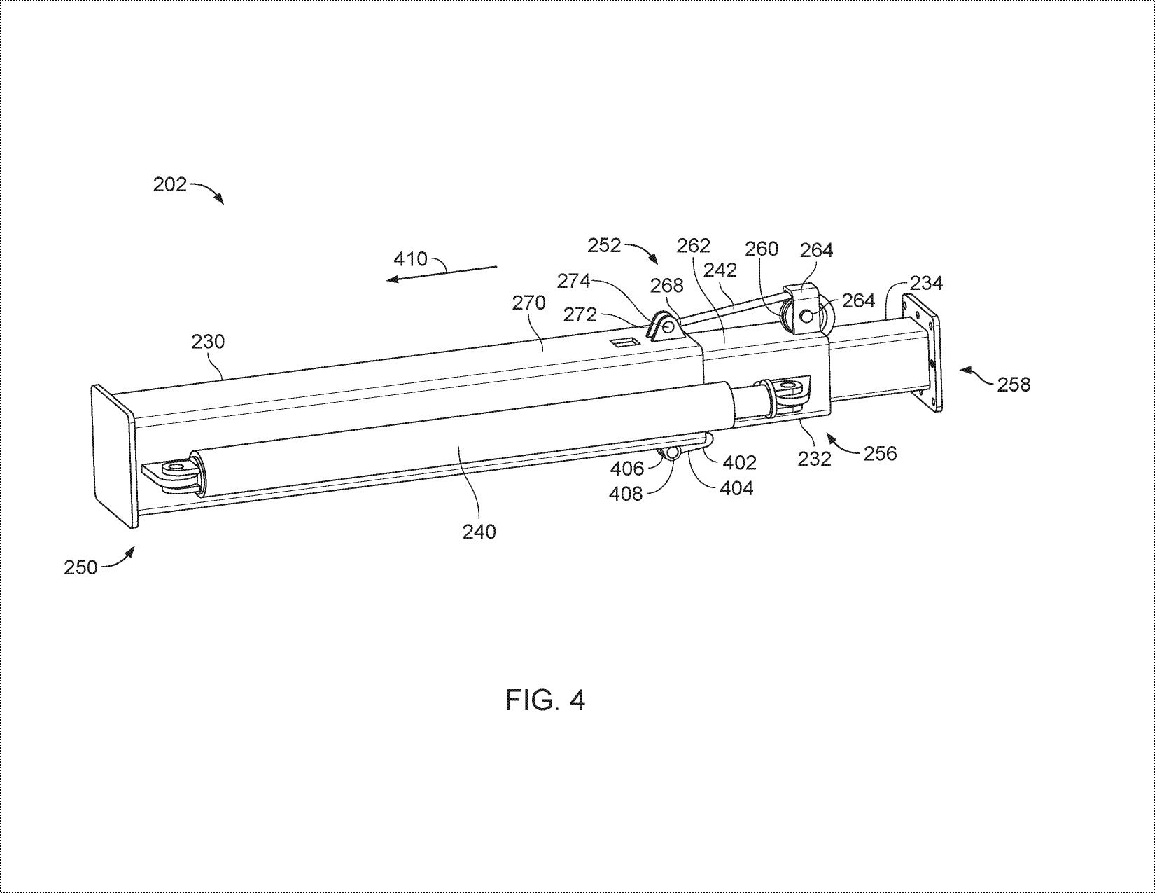

The arm assembly 202 has an extension wheel 260, a retraction wheel 504, the extension tether 242 (also referred to as the extension tether 242), and a retraction tether 402. The extension wheel 260 is shown in FIGS. 2-7 and 11. The retraction wheel 504 is shown in FIGS. 5, 7, and FIG. 11. The extension tether 242 is also referred to as the extension tether 242. The extension tether 242 is shown in FIGS. 2-7 and 11. The retraction tether 402 is shown in FIGS. 4, 5, 7, and FIG. 11.

The extension wheel 260 is coupled to an outer surface 262 of the intermediate beam 232. The extension wheel 260 is positioned at the distal end 256 of the intermediate beam 232. The extension tether 242 rides in extension wheel 260. The extension wheel 260 rotates freely as the extension tether 242 moves. The extension wheel 260 changes the direction of the extension tether 242 about the distal end 256 of the intermediate beam 232. A portion of the extension wheel 260 extends through the intermediate beam 232 from the top through a cutout on the top of the intermediate beam 232 at the distal end 256.

The extension wheel 260 has a diameter. In this implementation, the extension wheel 260 of the extension wheel 260 is between 5 ¼ inches and 6 ¼ inches. However, in other embodiments, the extension wheel 260 can have any suitable diameter.

The extension wheel 260 sits in a frame 264. A shaft 266 is mounted within the frame 264. The extension wheel 260 and rotates about the shaft 266. The frame 264 is mounted on the outer surface 262 of the intermediate beam 232.

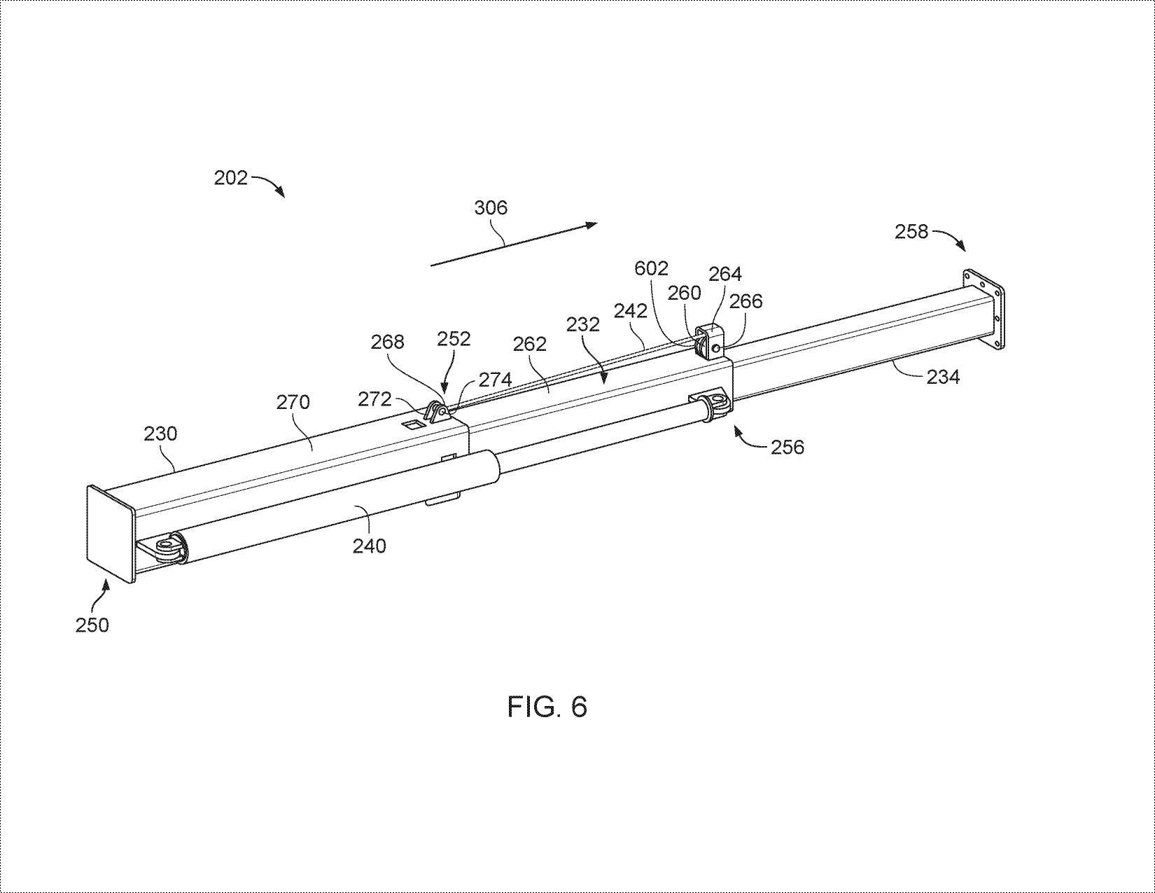

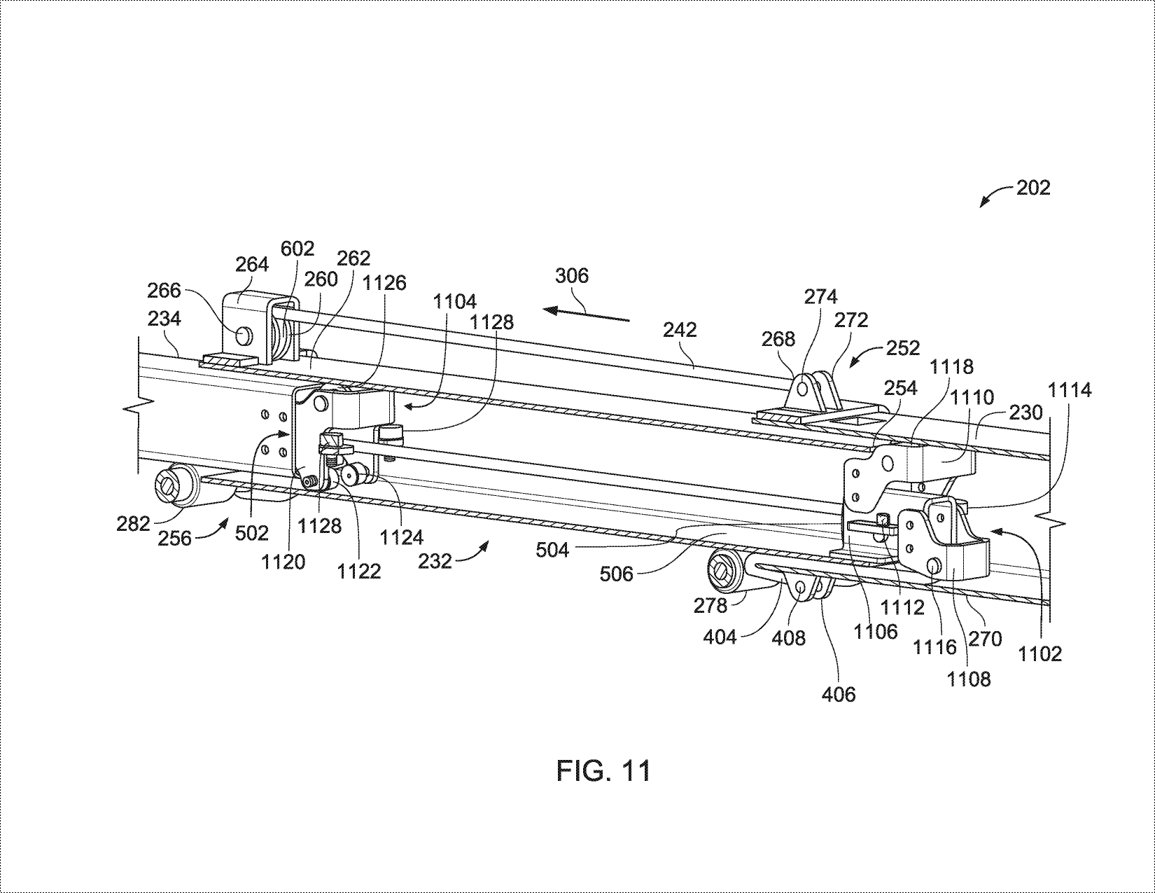

The extension wheel 260 has a groove 602 (shown in FIGS. 6 and 11). The groove 602 is sized to receive the extension tether 242. The extension tether 242 rides in the groove 602. In some implementations, the extension wheel 260 is a pulley (i.e., an extension pulley).

Referring to FIGS. 5, 7, and FIG. 11, the retraction wheel 504 is coupled to an inner surface 506 of the intermediate beam 232. The retraction wheel 504 is positioned at the proximal end 254 of the intermediate beam 232. The retraction tether 402 rides in retraction wheel 504. The retraction wheel 504 rotates freely as the retraction tether 402 moves. The retraction wheel 504 changes the direction of the retraction tether 402 about the proximal end 254 of the intermediate beam 232. A portion of the retraction wheel 504 extends through the intermediate beam 232 from bottom at the proximal end 254 through a cutout on the bottom of the intermediate beam 232 at the proximal end 254.

The retraction wheel 504 has a diameter. In this implementation, the retraction wheel 504 of the retraction wheel 504 is between 5 ¼ inches and 6 ¼ inches. However, in other embodiments, the retraction wheel 504 can have any suitable diameter.

The retraction wheel 504 sits in a frame 508. A shaft 510 is mounted within the frame 508. The retraction wheel 504 rotates about the shaft 510. The frame 508 is mounted on the inner surface 506 of the base beam 230.

The retraction wheel 504 has a groove. The groove of the retraction wheel 504 is sized to receive the retraction tether 402. The retraction tether 402 rides in the groove of the retraction wheel 504. In some implementations, the retraction wheel 504 is a pulley (i.e., a retraction pulley).

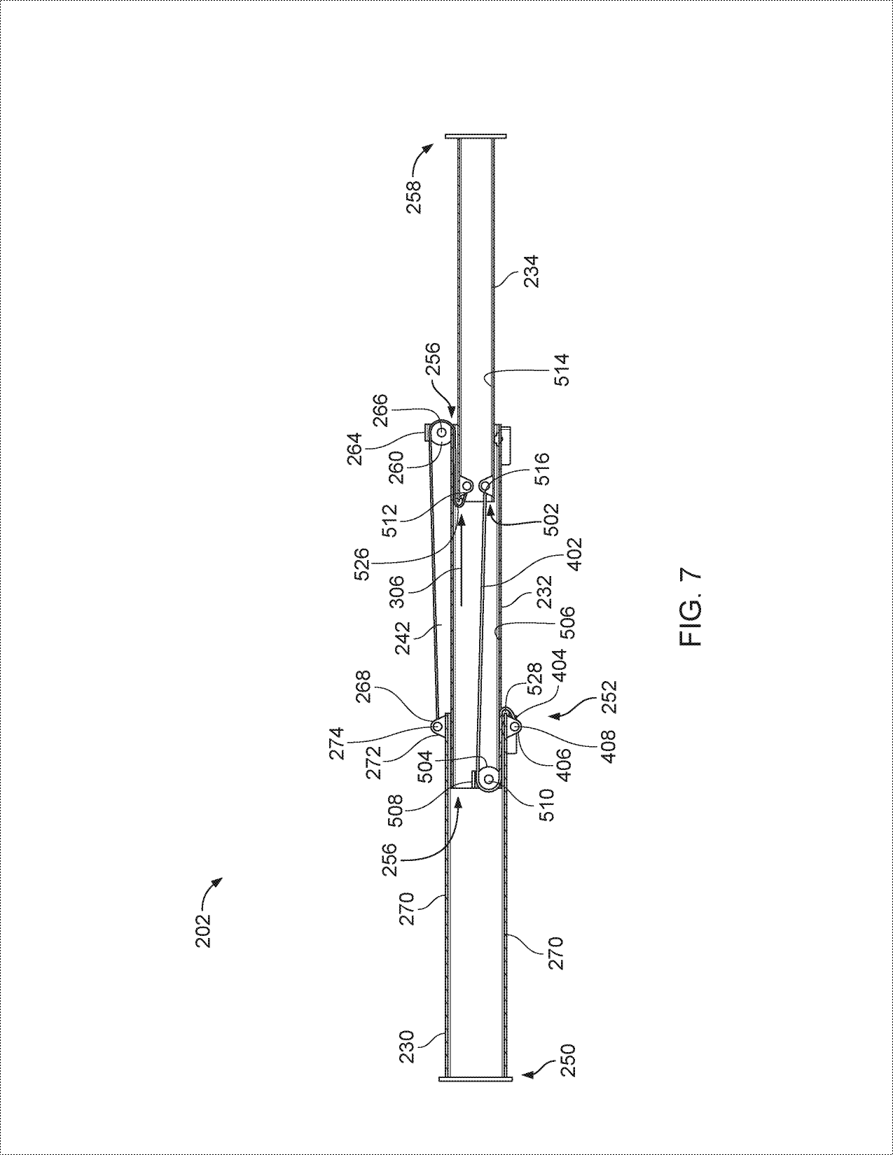

The extension tether 242 has a first end 512 (shown in FIGS. 5 and 7) and a second end 268 (shown in FIGS. 2-7 and 11). The first end 512 of the extension tether 242 is fixed to an inner surface 514 (shown in FIGS. 5 and 7) of the grabber beam 234. The second end 268 of the extension tether 242 is coupled to an outer surface 270 of the base beam 230.

The retraction tether 402 has a first end 516 (shown in FIGS. 5 and 7) and a second end 404 (shown in FIGS. 4-5 and 7). The first end 516 is coupled to the inner surface 514 of the grabber beam 234. The second end 404 is coupled to the outer surface 270 of the base beam 230.

The arm assembly 202 has a first bracket 272 and a first pin 274, shown in FIGS. 2-7 and 11. The first bracket 272 is coupled to the outer surface 270 of the distal end 252 of the base beam 230. The first bracket 272 receives the first pin 274. The first pin 274 couples to the first bracket 272. The second end 268 of the extension tether 242 is coupled to the first bracket 272 and the first pin 274. The first pin 274 fixes the second end 268 of the extension tether 242 to the first bracket 272. In some implementations, the second end 268 of the extension tether 242 has a loop through which the first pin 274 passes to couple the second end 268 of the extension tether 242 to the first bracket 272. The first bracket 272 holds the terminating second end 268 fixed to the base beam 230.

The arm assembly 202 has a second bracket 406 and a second pin 408, shown in FIGS. 4-5, 7, and FIG. 11. The second bracket 406 is coupled to the outer surface 270 of the distal end 252 of the base beam 230. The second bracket 406 receives the second pin 408. The second pin 408 couples to the second bracket 406. The second end 404 of the retraction tether 402 is coupled to the second bracket 406 and the second pin 408. The second pin 408 fixes the second end 404 of the retraction tether 402 to the second bracket 406. In some implementations, the second end 404 of the retraction tether 402 has a loop through which the second pin 408 passes to couple the second end 404 of the retraction tether 402 to the second bracket 406. The second bracket 406 holds the terminating second end 404 fixed to the base beam 230.

Referring to FIGS. 5 and 7, the arm assembly 202 has a third bracket 518 and a third pin 520. The third bracket 518 is coupled to the inner surface 514 of the proximal end 502 of the grabber beam 234. The third bracket 518 receives the third pin 520. The third pin 520 couples to the third bracket 518. The first end 512 of the extension tether 242 is coupled to the third bracket 518 and the third pin 520. The third pin 520 fixes the first end 512 of the extension tether 242 to the third bracket 518. In some implementations, the first end 512 of the extension tether 424 has a loop through which the third pin 520 passes to couple the first end 512 of the extension tether 242 to the third bracket 518. The third bracket 518 holds the terminating first end 512 fixed to the grabber beam 234.

The arm assembly 202 has a fourth bracket 522 and a fourth pin 524. The fourth bracket 522 is coupled to the inner surface 514 of the proximal end 502 of the grabber beam 234. The fourth bracket 522 receives the fourth pin 524. The fourth pin 524 couples to the fourth bracket 522. The first end 516 of the retraction tether 402 is coupled to the fourth bracket 522 and the fourth pin 524. The fourth pin 524 fixes the first end 516 of the retraction tether 402 to the fourth bracket 522. In some implementations, the first end 516 of the retraction tether 402 has a loop through which the fourth pin 524 passes to couple the first end 516 of the retraction tether 402 to the fourth bracket 522. The fourth bracket 522 holds the terminating first end 516 fixed to the grabber beam 234.

Referring to FIGS. 5 and 7-10, the arm assembly 202 has multiple guide blocks to guide the tethers 242, 402. The guide blocks include an extension block 526 and a retraction block 528. The extension block 526 is coupled to the proximal end 502 of the grabber beam 234. The extension block 526 receives the extension tether 242 and allows the extension tether 242 to slide relative to the extension block 526. The extension block 526 reverses the direction of the extension tether 242 about the grabber beam 234. The extension block 526 routes the extension tether 242 from between the intermediate beam 232 and the base beam 230 through an opening at the proximal end 502 of the grabber beam 234 into the interior space of the grabber beam 234. The extension block 526 is coupled about the distal end 252 of the grabber beam 234 about the inner surface 514 of the grabber beam 234 and an outer surface 530 of the grabber beam 234. The retraction block 528 is coupled to the distal end 252 of the base beam 230. The retraction block 528 receives the retraction tether 402 and allows the retraction tether 402 to slide relative to the retraction block 528. The retraction block 528 reverses the direction of the retraction tether 402 about the base beam 230. The retraction block 528 routes the retraction tether 402 from outside the arm assembly 202 to within the arm assembly 202 through the opening at the distal end 252 of the base beam 230. The retraction block 528 is coupled to the distal end 252 of the base beam 230 from an inner surface 532 of the base beam 230 to the outer surface 270 of the base beam 230.

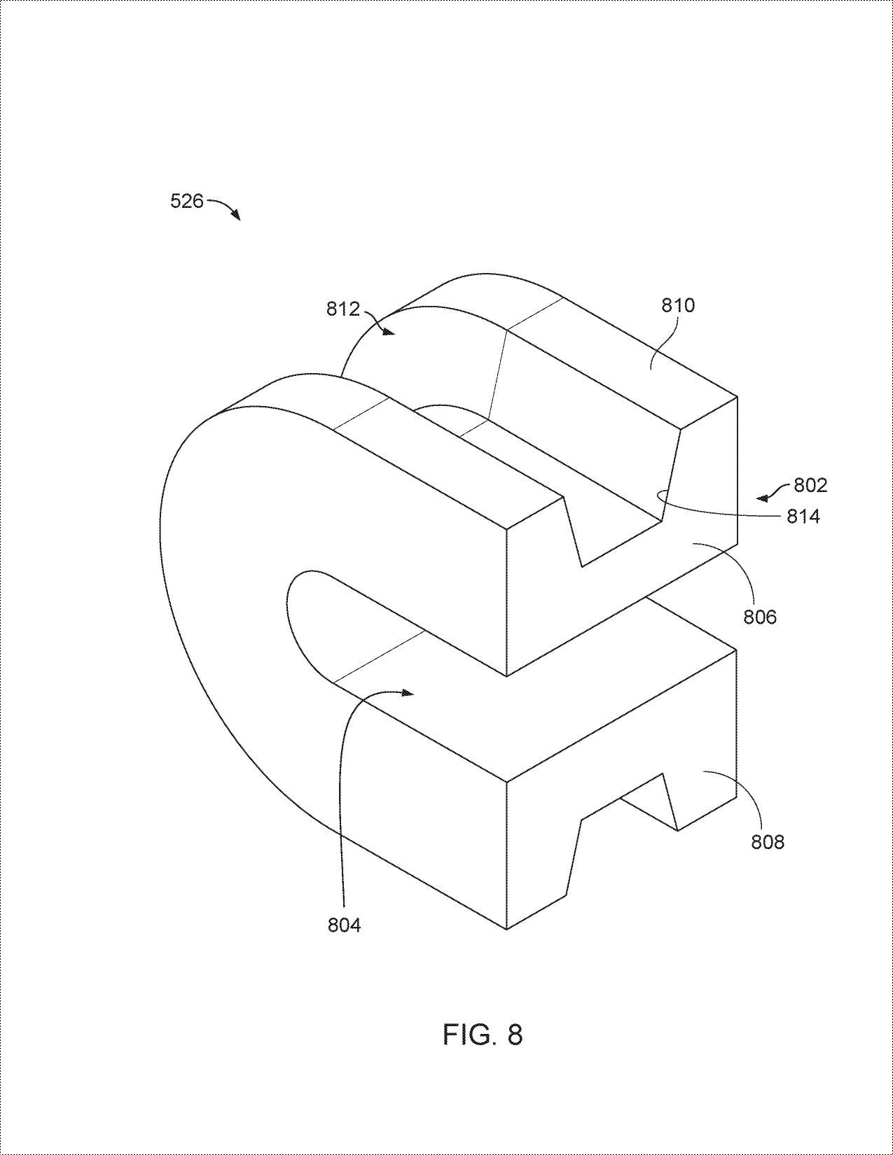

Referring to FIGS. 8-10 show the extension block 526 and retraction block 528. The extension block 526 and the retraction block 528 are generally similar. The extension block 526 has a body 802 that is a generally arcuate shape to fit about the distal end 252 of the grabber beam 234. The body 802 has a void 804 sized to receive the distal end 252 of the grabber beam 234 and mate with the inner surface 514 of the grabber beam 234 and the outer surface 530 of the grabber beam 234. The void 804 extends from a plane between a first surface 806 and a second surface 808. The body 802 has an outer surface 810. The outer surface 810 is arcuate.

The extension block 526 has a channel 812 extending from outer surface 810 into the body 802 toward the void 804. The channel 812 extends from the first surface 806 to the second surface 808. The channel 812 receives the extension tether 242 and allows the extension tether 242 slide about the distal end 252 of the grabber beam 234. The channel 812 has a U-shaped profile. The channel 812 has a trapezoidal cross-section 814. However, any suitable shaped cross-section may be used.

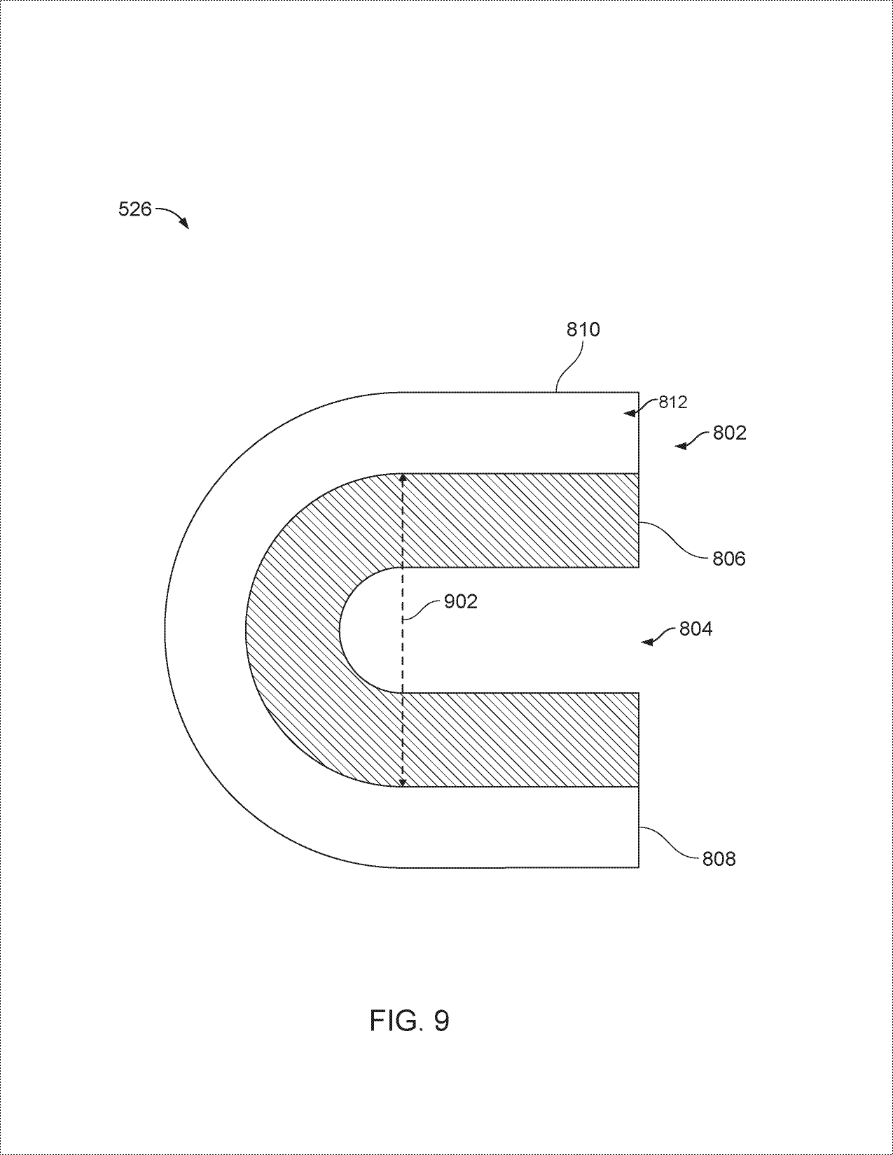

Referring to FIG. 9, the channel 812 has an inner diameter 902. The inner diameter 902 of the channel 812 can be between 0.7 inches and 0.8 inches.

Referring to FIGS. 2-11, the diameters of the extension wheel 260 and the retraction wheel 504 and the inner diameters 902 of the extension block 526 and retraction block 528 can be selected to increase the mechanical advantage or increase the speed of operation of the arm assembly 202. For example, a ratio of the diameter of the extension wheel 260 to the inner diameter 902 of the extension block 526 can be between 7.4:1 to 7.9:1.

Referring to FIGS. 5 and 7, the extension tether 242 is positioned along a first pathway. The length of the extension tether 242, and thus the first pathway, is static. That is, during operation of the arm assembly 202, the extension tether 242 does not extend or retract appreciably. The extension tether 242 is flexible and does not deform linearly.

The first pathway begins at a first location 534. The first location 534 is on the inner surface 514 of the grabber beam 234 and at the proximal end 502 of the grabber beam 234. The third bracket 518 is positioned at the first location 534. The terminating first end 512 of the extension tether 242 is at the first location 534. The first pathway extends from the first location 534 on the inner surface 514 of the grabber beam 234 and out the proximal end 502 of the grabber beam 234 to reverse direction about the extension block 526. The first pathway continues from the proximal end 502 of the arm assembly 202 between the outer surface 530 of the grabber beam 234 and the inner surface 506 of the intermediate beam 232. The first pathway extends along the intermediate beam 232 from the proximal end 502 of the grabber beam 234 toward the distal end 256 of the intermediate beam 232 and out the opening at the distal end 256 of the intermediate beam 232 to contact the extension wheel 260. The extension wheel 260 reverses the direction of the first pathway about the distal end 256 of the intermediate beam 232. The first pathway extends around the extension wheel 260 to a second location 536 on the base beam 230. The first bracket 272 is positioned at the second location 536. The extension tether 242 is disposed along the first pathway and extends from the first location 534 to the second location 536.

The retraction tether 402 is positioned along a second pathway. The length of the retraction tether 402, and thus the second pathway, is static. That is, during operation of the arm assembly 202, the retraction tether 402 does not extend or retract appreciably. The retraction tether 402 does not deform linearly. The second pathway begins at a third location 538. The third location 538 is on the inner surface 514 of the grabber beam 234 and at the proximal end 502 of the grabber beam 234. The fourth bracket 522 is positioned at the third location 538. The terminating first end 516 of the retraction tether 402 is at the third location 538. The second pathway extends from the third location 538 on the inner surface 514 of the grabber beam 234 and out the proximal end 502 of the grabber beam 234 to the retraction wheel 504. The second pathway reverses direction around the retraction wheel 504 about the proximal end 254 of the intermediate beam 232. The second pathway continues from the proximal end 254 of the intermediate beam 232 between the outer surface 262 of the intermediate beam 232 and the inner surface 532 of the base beam 230. The second pathway extends between the base beam 230 and the intermediate beam 232 from the proximal end 502 of the intermediate beam 232 toward the distal end 252 of the base beam 230 and out the opening at the distal end 252 of base beam 230 to contact the retraction block 528. The retraction block 528 reverses the direction of the second pathway about the distal end 252 of the base beam 230. The second pathway extends around the retraction block 528 to a fourth location 540. The second bracket 406 is positioned at the fourth location 540. The retraction tether 402 is disposed along the second pathway and extends from the third location 538 to the fourth location 540. The retraction tether 402 terminates at the fourth location 540.

Referring to FIGS. 2-7 and 11, the arm assembly 202 operates between the retracted position 204 and the extended position 302. When the arm assembly 202 is in the retracted position 204, to extend the arm assembly 202, the drive mechanism 240 (an actuator) extends. Since the drive mechanism 240 is coupled to the base beam 230 and the intermediate beam 232 and the base beam 230 is fixed, the intermediate beam 232 extends in a first direction as shown by arrow 306 in FIGS. 3 and 6-7. The first direction is a distal direction away from the refuse collection vehicle 100. Simultaneously, since the length of the extension tether 242 is fixed, the second end 268 of the extension tether 242 is fixed to the base beam 230 which does not move, and the first end 512 of the extension tether 242 is fixed to the grabber beam 234, the extension tether 242 exerts a pushing force on the proximal end 502 of the grabber beam 234 in the direction of arrow 306, pushing the grabber beam 234 from the retracted position 204 and the extended position 302. In this implementation, the magnitude of the pushing force can be between 3,632 and 5,448 pounds of force (lb_{f}) based on a factor of safety of approximately 2-3 on the actual load 1,816 lb_{f}.

To retract the arm assembly 202 when the arm assembly 202 is in the extended position 302, the drive mechanism 240 retracts. Since the drive mechanism 240 is coupled to the base beam 230 and the intermediate beam 232 and the base beam 230 is fixed, the intermediate beam 232 retracts in a second direction as shown by arrow 410 in FIGS. 4 and 5. The second direction is a proximal direction toward the refuse collection vehicle 100. Simultaneously, since the length of the retraction tether 402 is fixed, the second end 404 of the retraction tether 402 is fixed to the base beam 230 which does not move, and the first end 516 of the retraction tether 402 is fixed to the grabber beam 234, the retraction tether 402 exerts a pulling force on the proximal end 502 of the grabber beam 234 in the direction of arrow 410, pulling the grabber beam 234 from the extended position 302 and the retracted position 204. In this implementation, the magnitude of the pushing force can be between pushing force can be between 3,632 and 5,448 pounds of force (lb_{f}) based on a factor of safety of approximately 2-3 on the actual load 1,816 lb_{f}.

Referring to FIGS. 2, 3, and FIG. 11, the arm assembly 202 includes the second external roller assembly 238, the first external roller assembly 236, the first internal roller assembly 1102 (shown in FIG. 11), and the second internal roller assembly 1104 (shown in FIG. 11). The second external roller assembly 238 is coupled externally to the base beam 230 at the distal end 252 of the base beam 230 and extends distally from the base beam 230. The second external roller assembly 238 directly supports the intermediate beam 232, and indirectly supports the grabber beam 234. The second external roller assembly 238 allows the intermediate beam 232 to slide relative to the base beam 230. The first external roller assembly 236 is coupled externally to the intermediate beam 232 at the distal end 256 of the intermediate beam 232 and extends distally from the intermediate beam 232. The first external roller assembly 236 directly supports the grabber beam 234. The first external roller assembly 236 allows the grabber beam 234 to slide relative to the intermediate beam 232. The first internal roller assembly 1102 is coupled to the proximal end 254 of the intermediate beam 232 and extends in the proximal direction from the intermediate beam 232. The first internal roller assembly 1102 supports the intermediate beam 232 within the base beam 230. The second internal roller assembly 1104 is coupled to the proximal end 502 of the grabber beam 234 and extends in the proximal direction from the grabber beam 234. The second internal roller assembly 1104 supports the grabber beam 234 within the intermediate beam 232.

The first external roller assembly 236 has a first roller support plate 276 and a first roller 278. The first roller support plate 276 is generally L-shaped. The first roller 278 is coupled to the first roller support plate 276. The first roller support plate 276 extends the first roller 278 from the distal end 252 of the base beam 230. The intermediate beam 232 contacts the first roller 278. The first roller 278 supports the intermediate beam 232. The intermediate beam 232 slides on the first roller 278 as the first roller 278 rotates in the first roller support plate 276. The first bracket 272 is coupled to the first roller support plate 276. The first roller 278 can include one or more rollers.

The second external roller assembly 238 has a second roller support plate 280 and a second roller 282. The second roller support plate 280 is generally L-shaped. The second roller 282 is coupled to the second roller support plate 280. The second roller support plate 280 extends the second roller 282 from the distal end 256 of the intermediate beam 232. The grabber beam 234 contacts the second roller 282. The second roller 282 supports the grabber beam 234. The grabber beam 234 slides on the second roller 282 as the second roller 282 rotates in the second roller support plate 280. The frame 264 holding the extension wheel 260 is coupled to the second roller support plate 280. The second roller 282 can include one or more rollers.

Referring to FIG. 11, the first internal roller assembly 1102 is coupled to the inner surface 506 at the proximal end 254 of the intermediate beam 232. The first internal roller assembly 1102 extends from the proximal end 254 into the base beam 230. The first internal roller assembly 1102 allows the intermediate beam 232 to slide relative to the base beam 230 and support the intermediate beam 232 within the base beam 230. The frame 508 for the retraction wheel 504 is mounted to the inner surface 506 at the proximal end 254 of the intermediate beam 232. In some cases, the first internal roller assembly 1102 includes the frame 508 for the retraction wheel 504.

The first internal roller assembly 1102 has a set of rollers supporting the intermediate beam 232 in two axes. The set of rollers of the first internal roller assembly 1102 contact the inner surface 532 of the base beam 230 and rotate as the intermediate beam 232 moves relative to the base beam 230.

The first internal roller assembly 1102 has a first roller carrier bracket 1106, a second roller carrier bracket 1108, and a third roller carrier bracket 1110. The first roller carrier bracket 1106 is mounted to the inner surface 506 of the intermediate beam 232 at the proximal end 254 of the intermediate beam 232. In some cases, the first roller carrier bracket 1106 includes the frame 508 for the retraction wheel 504. The set of rollers of the first internal roller assembly 1102 includes one or more rollers 1112, 1114 mounted on each side of the first roller carrier bracket 1106 to support the intermediate beam 232 in the x-axis and to allow the intermediate beam 232 to slide relative to the base beam 230. The rollers 1112, 1114 extend from the first roller carrier bracket 1106 to contact the vertical walls of the base beam 230.

The second roller carrier bracket 1108 is mounted to the first roller carrier bracket 1106 and extends from the proximal end 254 of the intermediate beam 232 at the of the intermediate beam 232 into the grabber beam 234. The set of rollers includes a roller 1116 mounted in the second roller carrier bracket 1108 to support the intermediate beam 232 in the y-axis and to allow the intermediate beam 232 to slide relative to the base beam 230. The roller 1116 contacts the inner surface 532 of the base beam 230 and rotates relative to the top wall of the base beam 230.

The second roller carrier bracket 1108 is mounted to the first roller carrier bracket 1106 and extends from the proximal end 254 of the intermediate beam 232 into the grabber beam 234. The set of rollers include a roller 1116 mounted in the second roller carrier bracket 1108 to support the intermediate beam 232 in the y-axis and to allow the intermediate beam 232 to slide relative to the base beam 230. The roller 1116 contacts the inner surface 532 of the base beam 230 and rotates relative to the bottom wall of the base beam 230.

The third roller carrier bracket 1110 is mounted to the first roller carrier bracket 1106 and extends from the proximal end 254 of the intermediate beam 232 into the grabber beam 234. The set of rollers includes a roller 1118 mounted in the second roller carrier bracket 1108 to support the intermediate beam 232 in the y-axis and to allow the intermediate beam 232 to slide relative to the base beam 230. The roller 1118 contacts the inner surface 532 of the base beam 230 and rotates relative to the top wall of the base beam 230.

The second internal roller assembly 1104 is coupled to the proximal end 502 of the grabber beam 234 and extends in the proximal direction from the grabber beam 234. The second internal roller assembly 1104 supports the grabber beam 234 within the intermediate beam 232. The second internal roller assembly 1104 has a roller carrier bracket 1120 and a set of rollers. The roller carrier bracket 1120 is mounted to the inner surface 514 of the grabber beam 234 at the proximal end 254 of the grabber beam 234. The roller carrier bracket 1120 extends from the proximal end 502 of the grabber beam 234 into the intermediate beam 232. In some cases, the roller carrier bracket 1120 includes the fourth bracket 522. The set of rollers of the second internal roller assembly 1104 include one or more rollers 1122, 1124 mounted in the roller carrier bracket 1120 to support the grabber beam 234 in the intermediate beam 232 in the y-axis. The rollers 1122, 1124 contact the inner surface 506 of the intermediate beam 232 and rotate as the grabber beam 234 extends and retracts. The set of rollers of the second internal roller assembly 1104 includes a roller 1126 mounted in the roller carrier bracket 1120. The roller 1126 extends from the proximal end 502 of the grabber beam 234 to contact the upper wall of the intermediate beam 232. The roller 1126 supports the grabber beam 234 in the intermediate beam 232 in the y-axis. The roller 1126 rotates as the grabber beam 234 extends and retracts. The set of rollers for the second internal roller assembly 1104 includes rollers 1128, 1130. The rollers 1128, 1130 extend laterally in the x-axis to contact the side walls of the intermediate beam 232. The rollers 1128, 1130 rotate as the grabber beam 234 moves to extend and retract the arm assembly 202.

The second external roller assembly 238, the first external roller assembly 236, the first internal roller assembly 1102, and the second internal roller assembly 1104 allow the intermediate beam 232 and the grabber beam 234 to slide. The second external roller assembly 238, the first external roller assembly 236, the first internal roller assembly 1102, and the second internal roller assembly 1104 account for movement of the intermediate beam 232 and the grabber beam 234 when there is bouncing or jostling of components during use or transit. In this implementation, the second internal roller assembly 1102 is different than the first internal roller assembly 1104 because the first internal roller assembly 1104 can include the retraction wheel 504, while the second internal roller assembly 1102 includes the termination of the flexible tether 242 at the fourth bracket 522.

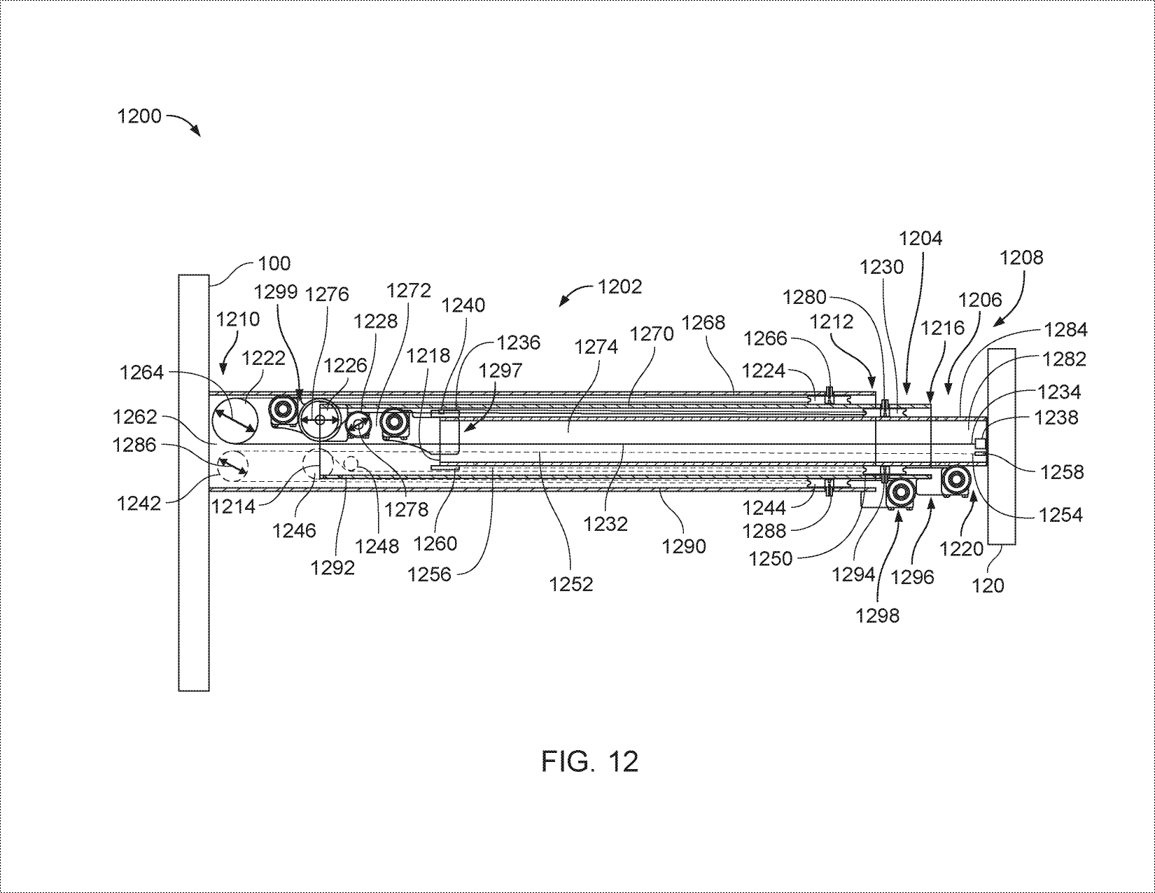

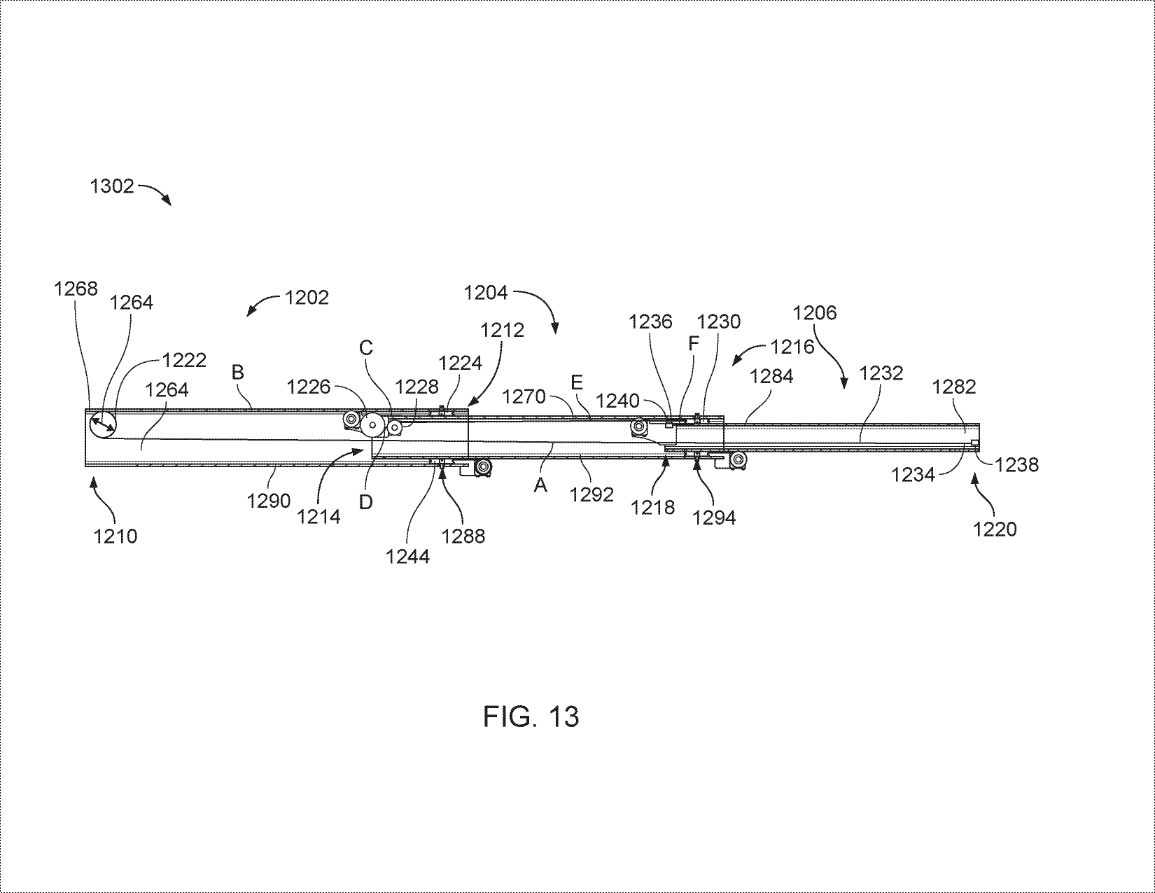

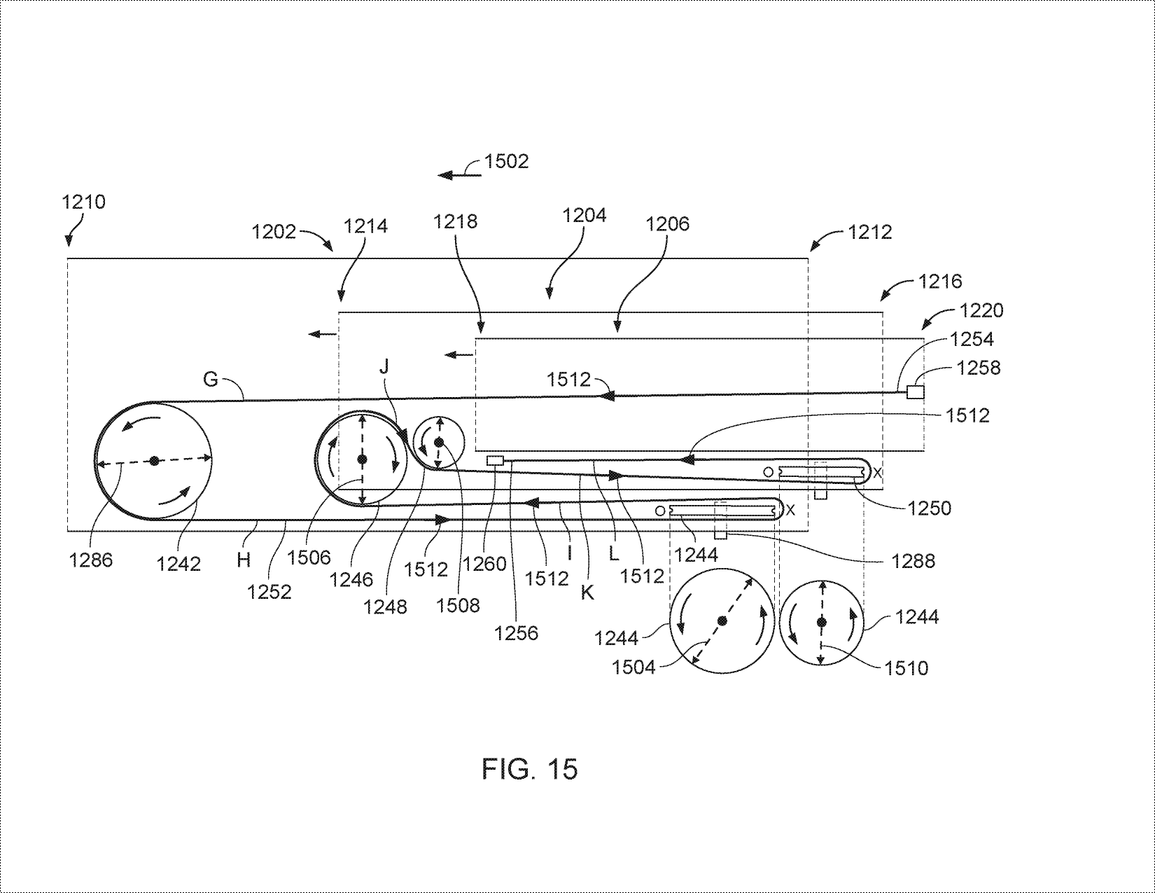

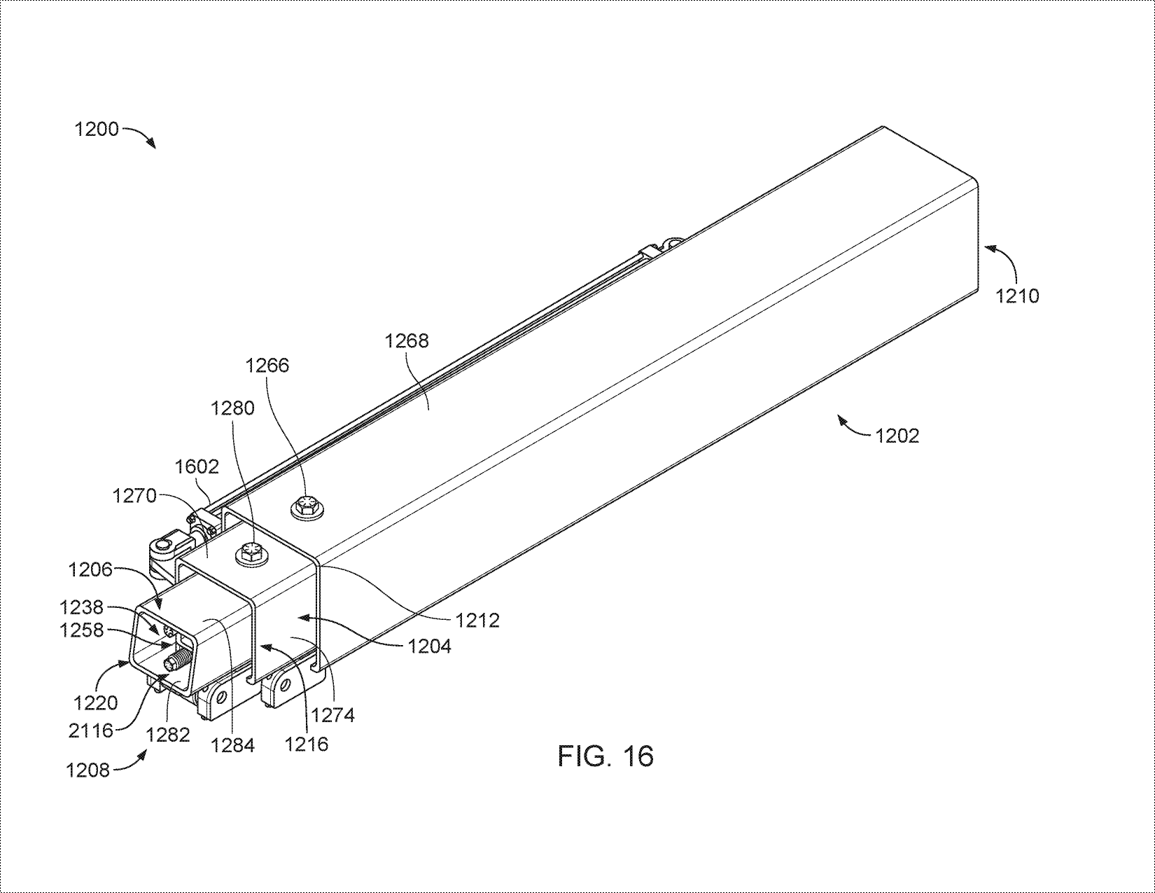

Referring to FIGS. 1-3 and 12-20, another arm assembly 1200 for extending and retracting the grabber assembly 122 is shown. The arm assembly 1200 includes three sections, including a base beam 1202, an intermediate beam 1204, a grabber beam 1206, and a drive mechanism 1602 (shown in FIGS. 16-20). The drive mechanism 1602 imparts motion (e.g., provides sufficient motive force and torque) to extend and retract the telescoping sections (the base beam 1202, the intermediate beam 1204, and the grabber beam 1206) such that the container lift 120 and the grabber assembly 122 are moved toward or away from the refuse collection vehicle 100. The arm assembly 1200 actuates between a retracted position 1208 (shown in FIGS. 12, 14, and 16-20)) and an extended position 1302 (shown in FIGS. 13 and 15).

Referring to FIGS. 12-20, each of the base beam 1202, the intermediate beam 1204, and the grabber beam 1206 have a proximal end and a distal end. The proximal ends are closer to the center of the refuse collection vehicle 100 than the respective distal ends. The distal ends are farther from the center of the refuse collection vehicle 100 than the respective proximal ends and closer to the grabber assembly 122. The base beam 1202 has a proximal end 1210 and a distal end 1212. The proximal end 1210 of the base beam 1202 is coupled to the body of the refuse collection vehicle 100. The proximal end 1210 of the base beam 1202 can be coupled to the frame 104. The distal end 1212 of the base beam 1202 is open to receive the intermediate beam 1204. The intermediate beam 1204 slides within the base beam 1202.

The intermediate beam 1204 has a proximal end 1214 and a distal end 1216. The proximal end 1214 of the intermediate beam 1204 remains within the base beam 1202 when the arm assembly 1200 is actuated between the retracted position 1208 and the extended position 1302. The distal end 1216 of the intermediate beam 1204 extends externally to the base beam 1202. The distal end 1216 of the intermediate beam 1204 is open to allow the grabber beam 1206 to move within the intermediate beam 1204. The grabber beam 1206 has a proximal end 1218 and a distal end 1220. The proximal end 1218 of the grabber beam 1206 remains within the intermediate beam 1204 when the arm assembly 1200 is actuated between the retracted position 1208 and the extended position 1302. The distal end 1220 of the grabber beam 1206 is coupled to the container lift 120.

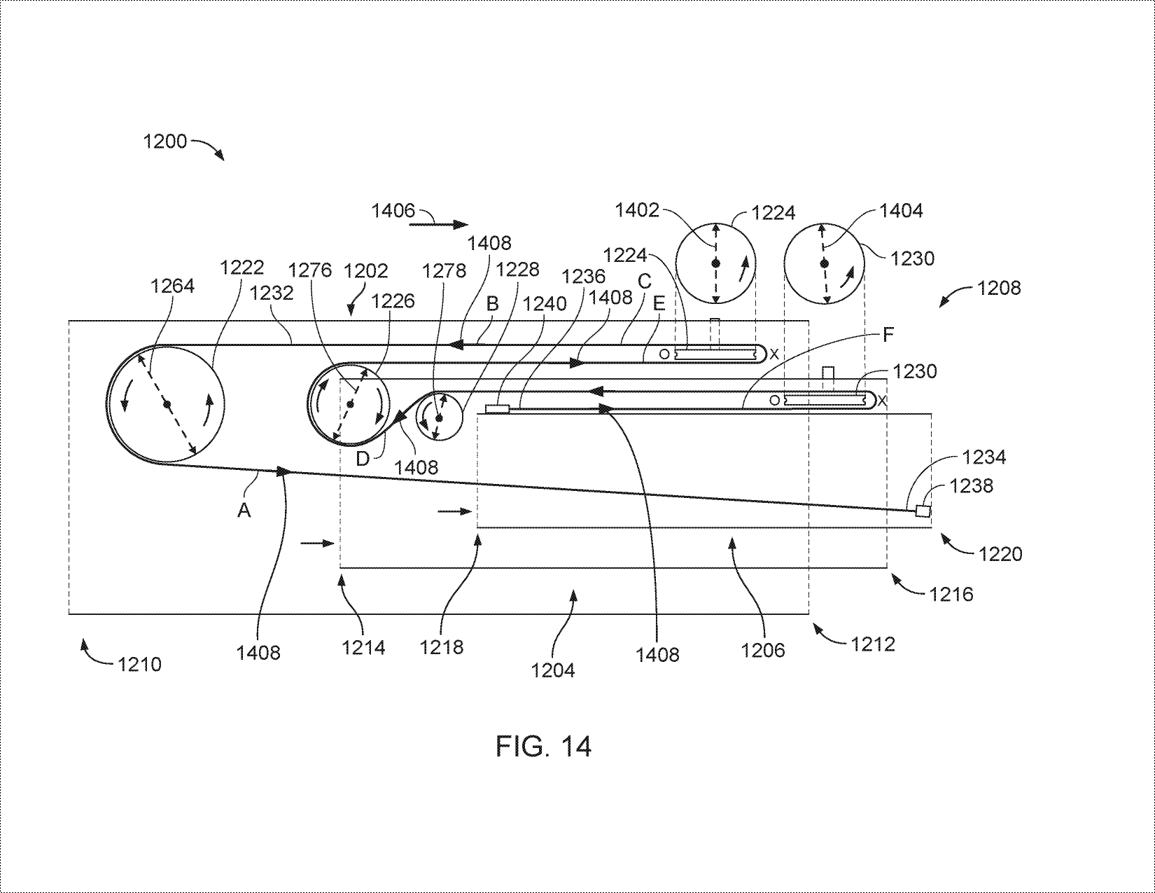

The arm assembly 1200 has multiple wheels (a first wheel 1222, a second wheel 1224, a third wheel 1226, a fourth wheel 1228, and a fifth wheel 1230) and a first tether 1232. In FIGS. 14-15 and 24, the first tether 1232 is shown routed above and below the second wheel 1224 and the fifth wheel 1230 for clarity to show the routing path. The first tether 1232 has a first end 1234 and a second end 1236. The first end 1234 of the first tether 1232 terminates on the grabber beam 1206 at a first location 1238 and the second end 1236 terminates on the grabber beam 1206 at a second location 1240. The first tether 1232 extends from the first location 1238 on the grabber beam 1206 between the first wheel 1222; the second wheel 1224, the third wheel 1226, the fourth wheel 1228, and the fifth wheel 1230 to the second location 1240 on the grabber beam 1206. The first tether 1232 is supported in the arm assembly 1200 by the first wheel 1222, the second wheel 1224, the third wheel 1226, the fourth wheel 1228, and the fifth wheel 1230. In FIGS. 15 and 18-20, the first tether 1232 is not shown for clarity.

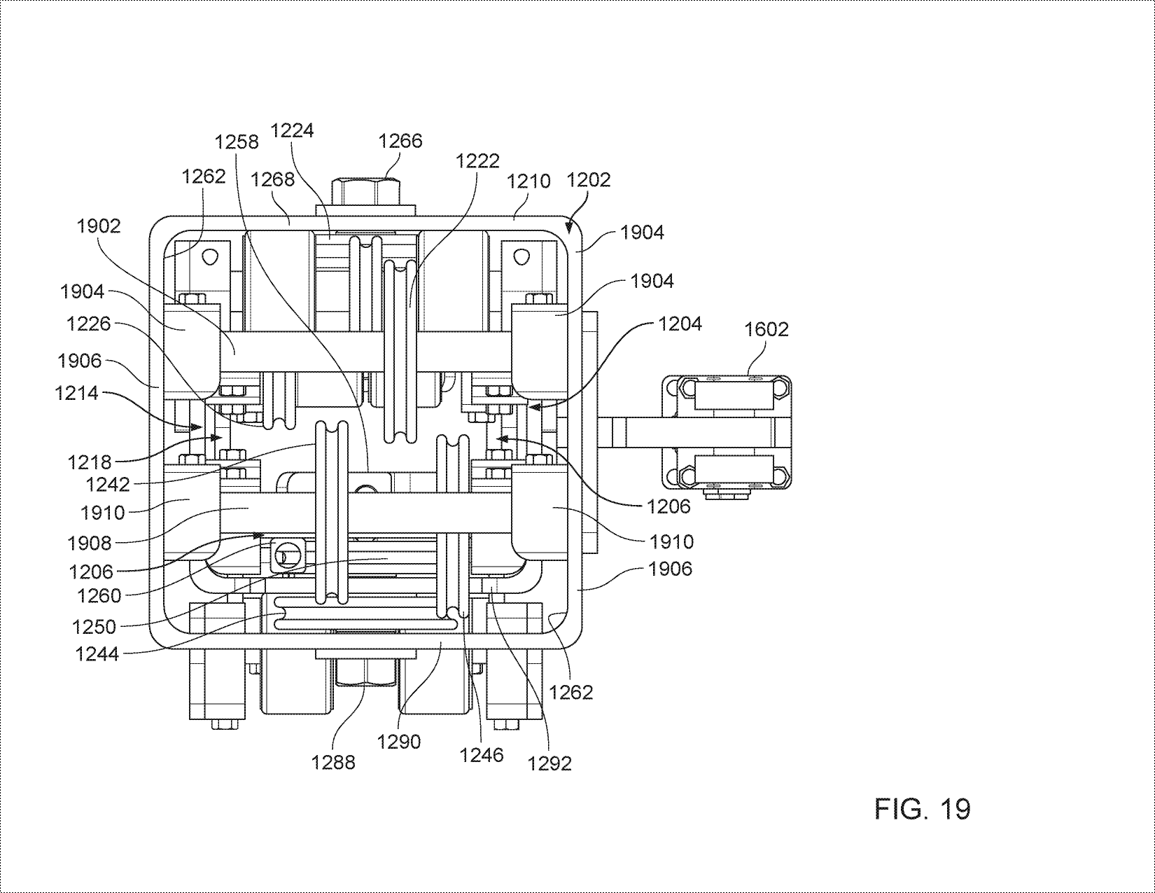

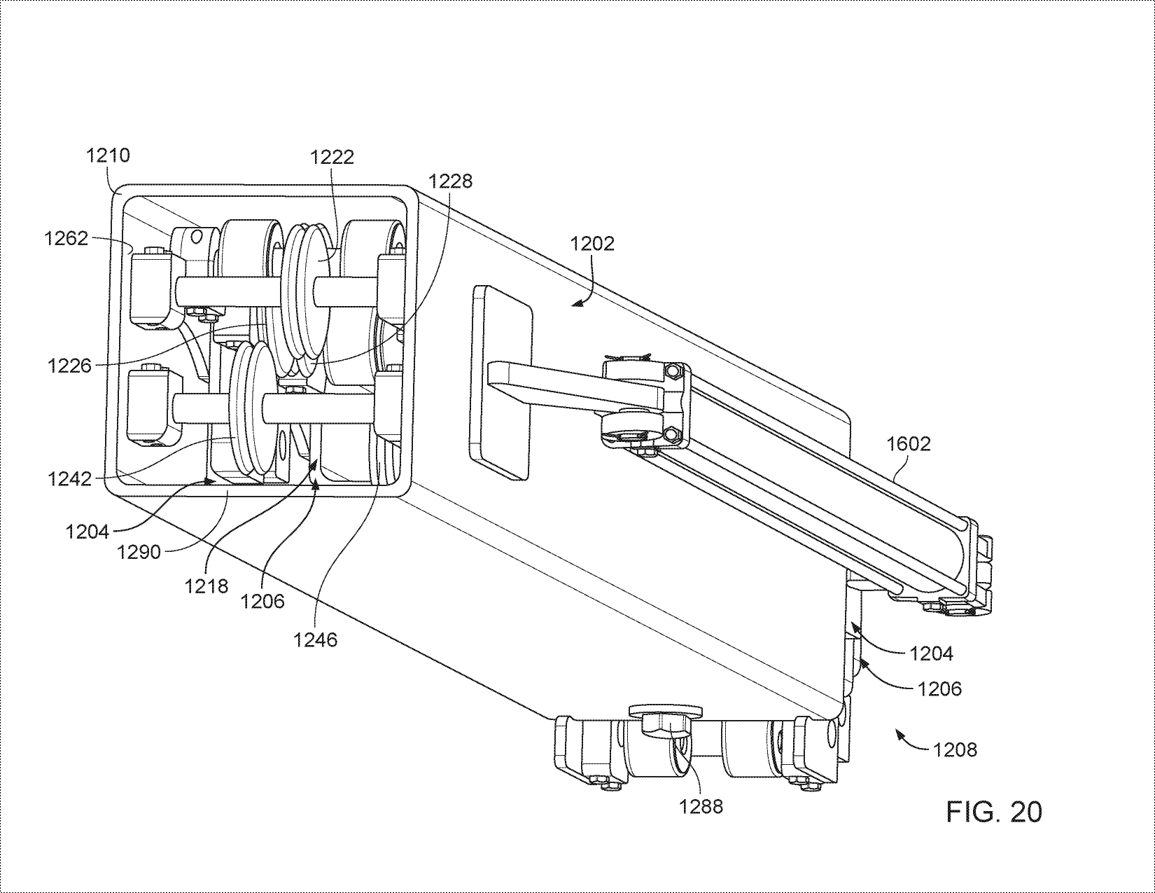

The first wheel 1222 is mounted in the base beam 1202. The first wheel 1222 is coupled to an inner surface 1262 of the base beam 1202. The first wheel 1222 is mounted in the proximal end 1210 of the base beam 1202. Referring to FIGS. 19-20, the arm assembly 1200 has a shaft 1902 and bearings 1904. The bearings 1904 are mounted to the vertical walls 1906 of the base beam 1202 on the inner surface 1262. The shaft 1902 extends into the bearings 1904. The first wheel 1222 is coupled to the shaft 1902. The first wheel 1222 and the shaft 1902 are free to rotate about an axis of the shaft 1902. The bearings 1904 allow the shaft 1902 and the first wheel 1222 to rotate. The first wheel 1222 is oriented vertically in the arm assembly 1200 (i.e., vertical to the ground on which the refuse collection vehicle 100 rests).

The first wheel 1222 receives the first tether 1232. The first wheel 1222 rotates responsive to the first tether 1232 moving relative to the first wheel 1222. The first wheel 1222 has a groove. The groove of the first wheel 1222 is sized to receive the first tether 1232. The first tether 1232 rides in the groove of the first wheel 1222.

The first wheel 1222 has a diameter 1264. In this implementation, the diameter 1264 of the first wheel 1222 is between 4 and 6 inches. The diameter of the wheels is dependent on the diameter of the tether due to a D/d ratio. In this embodiment, the wheels are scaled for 5/16” wire rope that has a minimum bend diameter of approximately four inches. In some implementations, the diameter of wheels is as large as possible so as to not bend the wire rope too sharply. The horizontally oriented wheels (the second wheel 1224 and the fifth wheel 1230) may be as large as the surrounding beam allows for. The rear-most wheels (i.e., proximal) may be constrained in size by the need to route the wire rope from the top and bottom of the beam to the center. Therefore, the first wheel 1222 and first wheel 1242 should sit relatively closer to the minimum bend diameter and not less than the minimum bend diameter of the wire rope. However, in other implementations, the first wheel 1222 may have any suitable diameter 1264.

The second wheel 1224 is mounted to the inner surface 1262 of the base beam 1202 at the distal end 1212 of the base beam 1202. The second wheel 1224 is oriented horizontally in the arm assembly 1200. The second wheel 1224 rests in a space between the base beam 1202 and the intermediate beam 1204. The arm assembly 1200 includes a fastener 1266 to couple the second wheel 1224 to the base beam 1202. The fastener 1266 includes a bolt, multiple washers, a ball bearing, and an internally threaded bearing insert. The internally threaded insert fits inside the ball bearing. The bolt extends through the top wall 1268 of the base beam 1202. The second wheel 1224 rotates about the shaft of the bolt, is held in place by the internally threaded insert, and is supported by the ball bearing. The second wheel 1224 is oriented orthogonally to the first wheel 1222.

The second wheel 1224 receives the first tether 1232. The second wheel 1224 rotates responsive to the first tether 1232 moving relative to the second wheel 1224. The second wheel 1224 has a groove. The groove of the second wheel 1224 is sized to receive the first tether 1232. The first tether 1232 rides in the groove of the second wheel 1224.

The second wheel 1224 has a diameter 1402 (shown in FIG. 14). In this implementation, the diameter 1402 of the second wheel 1224 is greater than or equal to four inches. The diameter 1402 is less than the internal width of base beam 1202. However, in other implementations, the second wheel 1224 can have any suitable diameter 1402.

The third wheel 1226 is coupled to the proximal end 1214 of the intermediate beam 1204. The third wheel 1226 at least partially extends from the proximal end 1214 of the intermediate beam 1204 into the base beam 1202. At least a portion of the third wheel 1226 extends above a top wall 1270 of the intermediate beam 1204. In some cases, a portion of the proximal end 1214 of the intermediate beam 1204 is cut out to allow the third wheel 1226 to extend above the top wall 1270 of the intermediate beam 1204. The third wheel 1226 is mounted to a bearing. The bearing is mounted to an inner surface 1272 of the vertical wall 1274 of intermediate beam 1204. The bearing is positioned on the inner surface 1272 of the intermediate beam 1204 to extend the third wheel 1226 from the proximal end 1214 of the intermediate beam 1204 into base beam 1202. The third wheel 1226 is oriented vertically in the arm assembly 1200. The third wheel 1226 rotates relative to the bearing.

The third wheel 1226 receives the first tether 1232. The third wheel 1226 rotates responsive to the first tether 1232 moving relative to the third wheel 1226. The third wheel 1226 has a groove. The groove of the third wheel 1226 is sized to receive the first tether 1232. The first tether 1232 rides in the groove of the third wheel 1226.

The third wheel 1226 has a diameter 1276. The diameter 1276 of the third wheel 1226 is between four and six inches. However, in other implementations, the third wheel 1226 may have any suitable diameter.

The fourth wheel 1228 is coupled at the proximal end 1214 of the intermediate beam 1204, inward (i.e., in the distal direction) from the third wheel 1226. The fourth wheel 1228 is offset from the third wheel 1226 along a length of the intermediate beam 1204 extending between the proximal end 1214 and the distal end 1216 of the intermediate beam 1204. The fourth wheel 1228 is mounted to a bearing. The bearing is mounted to the inner surface 1272 of the vertical wall 1274 of intermediate beam 1204. The bearing is positioned on the inner surface 1272. The fourth wheel 1228 is oriented vertically in the arm assembly 1200. The fourth wheel 1228 rotates relative to the bearing.

The fourth wheel 1228 receives the first tether 1232. The fourth wheel 1228 rotates responsive to the first tether 1232 moving relative to the fourth wheel 1228. The fourth wheel 1228 has a groove. The groove of the fourth wheel 1228 is sized to receive the first tether 1232. The first tether 1232 rides in the groove of the fourth wheel 1228.

The fourth wheel 1228 has a diameter 1278. In this implementation, the diameter 1278 of the fourth wheel 1228 is between two and three inches. The diameter 1278 of the fourth wheel 1228 can be approximately half of the diameter 1264 of the first wheel 1222. In this implementation, the diameter 1278 of the fourth wheel 1228 is less than the diameter 1276 of the third wheel 1226. However, in other implementations, the fourth wheel 1228 may have any suitable diameter 1278.

A center of the fourth wheel 1228 is offset vertically from a center of the third wheel 1226. One or both of the difference in diameters between the third wheel 1226 and the fourth wheel 1228 and the vertical offset between the centers of the third wheel 1226 and the fourth wheel 1228 change a vertical height of the first tether 1232 in the arm assembly 1200. The third wheel 1226 and the fourth wheel 1228 alter the height of the first tether 1232 to align the first tether 1232 to be positioned between the intermediate beam 1204 and the grabber beam 1206.

The fifth wheel 1230 is mounted at the distal end 1216 of the intermediate beam 1204. The fifth wheel 1230 is oriented horizontally in the arm assembly 1200. The fifth wheel 1230 is mounted to the inner surface 1272 of the top wall 1270 of the intermediate beam 1204 at the distal end 1216 of the intermediate beam 1204. The fifth wheel 1230 rests in a space between the intermediate beam 1204 and the grabber beam 1206. The arm assembly 1200 includes a fastener 1280 to couple the fifth wheel 1230 to the intermediate beam 1204. The fastener 1280 includes a bolt, multiple washers, a ball bearing, and an internally threaded bearing insert. The internally threaded insert fits inside the ball bearing. The bolt extends through the top wall 1270 of the intermediate beam 1204. The fifth wheel 1230 rotates about the shaft of the bolt, is held in place by the internally threaded insert, and is supported by the ball bearing. The fifth wheel 1230 is oriented orthogonally to the fourth wheel 1228.

The fifth wheel 1230 receives the first tether 1232. The fifth wheel 1230 rotates responsive to the first tether 1232 moving relative to the fifth wheel 1230. The fifth wheel 1230 has a groove. The groove of the fifth wheel 1230 is sized to receive the first tether 1232. The first tether 1232 rides in the groove of the fifth wheel 1230.

The fifth wheel 1230 has a diameter 1404 (shown in FIG. 14). The diameter 1404 of the fifth wheel 1230 is between two and three inches. The diameter 1404 of the fifth wheel 1230 can be approximately half of the diameter 1264 of the first wheel 1222. However, in other implementations, the fifth wheel 1230 may have any suitable diameter.

The diameters of the first wheel 1222, the second wheel 1224, the third wheel 1226, the fourth wheel 1228, and the fifth wheel 1230 can be selected to increase the mechanical advantage or increase the speed of operation of the arm assembly 1200.

The first end 1234 of the first tether 1232 terminates at the first location 1238. The first location 1238 is on an inner surface 1282 of the grabber beam 1206. The second end 1236 of the first tether 1232 terminates at the second location 1240 on an outer surface 1284 of the grabber beam 1206. The length of the first tether 1232, and thus the first pathway, is static. That is, during operation of the arm assembly 1200, the first tether 1232 does not extend or retract appreciably. The first tether 1232 does not deform linearly.

The first tether 1232 is positioned along a first pathway. The first pathway of the arm assembly 1200 begins at the first location 1238 on the inner surface 1282 of the grabber beam 1206. The first pathway extends from the first location 1238 on the inner surface 1282 of the grabber beam 1206, out the proximal end 1218 of the grabber beam 1206, out the proximal end 1214 of the intermediate beam 1204, to the first wheel 1222. The first pathway continues around the first wheel 1222 vertically changed the height of the first tether 1232. The first pathway changes direction between the proximal direction to the distal direction around the base beam 1202, the intermediate beam 1204, and the grabber beam 1206. The first pathway continues from the first wheel 1222 to the distal end 1212 of the base beam 1202 between the intermediate beam 1204 and the base beam 1202 to the second wheel 1224. The first pathway continues around the second wheel 1224 horizontally, reversing direction toward the proximal end 1214 of the intermediate beam 1204 to the third wheel 1226. The first pathway extends around the third wheel 1226 to the fourth wheel 1228 and about the fourth wheel 1228 to change a vertical height of the first tether 1232 to align the first tether 1232 to pass toward the distal end 1216 of the intermediate beam 1204 in between the intermediate beam 1204 and the grabber beam 1206 to the fifth wheel 1230. The first pathway continues around the fifth wheel 1230 horizontally, reversing direction toward the proximal end 1218 of the grabber beam 1206 to the second location 1240 on the grabber beam 1206 on the outer surface 1284 of the grabber beam 1206. The first tether 1232 is disposed along the first pathway.

Referring to FIG. 14, the first pathway defines segments of the first tether 1232 between each component. Segment “A” of the first tether 1232 extends between the first location 1238 on the inner surface 1282 of the grabber beam 1206 and the first wheel 1222. Segment “B” extends from the first wheel 1222 to the second wheel 1224. Segment “C” extends from the second wheel 1224 to the third wheel 1226. Segment “D” extends from the third wheel 1226 to the fourth wheel 1228. Segment “E’’ extends from the fourth wheel 1228 to the fifth wheel 1230. Segment “F” extends from the fifth wheel 1230 to the second location 1240 on the outer surface 1284 of the grabber beam 1206.

Referring to FIGS. 12-14, operation of the drive mechanism 1602 (an actuator) in a first direction 1406 extends the intermediate beam 1204 relative to the base beam 1202. Since the length of the first tether 1232 is fixed, the first end 1234 and the second end 1236 are fixed to the grabber beam 1206, and the first tether 1232 extends along the first pathway, the first tether 1232 transfers a first force from the intermediate beam 1204 to the grabber beam 1206 by moving the first tether 1232 along the first pathway and rotating the first wheel 1222, the second wheel 1224, the third wheel 1226, the fourth wheel 1228, and the fifth wheel 1230. Responsive to moving the first tether 1232 along the first pathway, the grabber beam 1206 moves in the first direction 1406, sliding relative to the intermediate beam 1204, from the retracted position 1208 to the extended position 1302.

The drive mechanism 1602 is coupled between the base beam 1202 and the intermediate beam 1204. The base beam 1202 is fixed to the refuse collection vehicle 100. When the drive mechanism 1602 extends in the first direction 1406 distally, the drive mechanism 1602 imparts a force in the first direction 1406 to the intermediate beam 1204. The intermediate beam 1204 extends in the first direction 1406. The first tether 1232 is in tension in the direction of arrows 1408 along the first pathway and pulls the grabber beam 1206 in the first direction 1406 to move the arm assembly 1200 from the retracted position 1208 to the extended position 1302. As the first tether 1232 moves, the third wheel 1226 rotates clockwise and slides along the first tether 1232. The first wheel 1222 and the fourth wheel 1228 rotate in the counterclockwise direction. The second wheel 1224 and the fifth wheel 1230, when viewed from the top, rotate in the counterclockwise direction. A length of segment “A” increases to a maximum length as the distal end 1220 of the grabber beam 1206 moves from the retracted position 1208 to the extended position 1302. A length of segment “B” is constant since the both the first wheel 1222 and the second wheel 1224 are mounted on the base beam 1202. A length of segment “C” decreased a minimum length as the proximal end 1214 approaches the distal end 1212 of the intermediate beam 1204. A length of segment “D” is constant since both the third wheel 1226 and the fourth wheel 1228 are mounted on the intermediate beam 1204. A length of segment “E” is constant since the fourth wheel 1228 and the fifth wheel 1230 are both mounted on the intermediate beam 1204. A length of segment “F” decreased to a minimum as the tension in the first direction 1406 pulls the grabber beam 1206 in the first direction 1406.

In this implementation, the magnitude of the force in the first direction is high enough to move the mechanism to the maximum allotted working load of the tether 1232.

Referring to FIGS. 12-13, 15, and 24, operation of the drive mechanism 1602 in the second direction 1502 (contracting toward the refuse collection vehicle 100) retracts the intermediate beam 1204 relative to the base beam 1202. Since the length of the first tether 1232 is fixed, the first end 1234 and the second end 1236 are fixed to the grabber beam 1206, and the first tether 1232 extends along the first pathway, the first tether 1232 transfers a second force from the intermediate beam 1204 to the grabber beam 1206 by moving the first tether 1232 along the first pathway and rotating the first wheel 1222, the second wheel 1224, third wheel 1226, fourth wheel 1228, and the fifth wheel 1230 in the opposite directions from those described in reference to FIG. 14. Responsive to moving the first tether 1232 along the first pathway, the grabber beam 1206 moves in the second direction 1502, sliding relative to the intermediate beam 1204, from the extended position 1302 to the retracted position 1208.

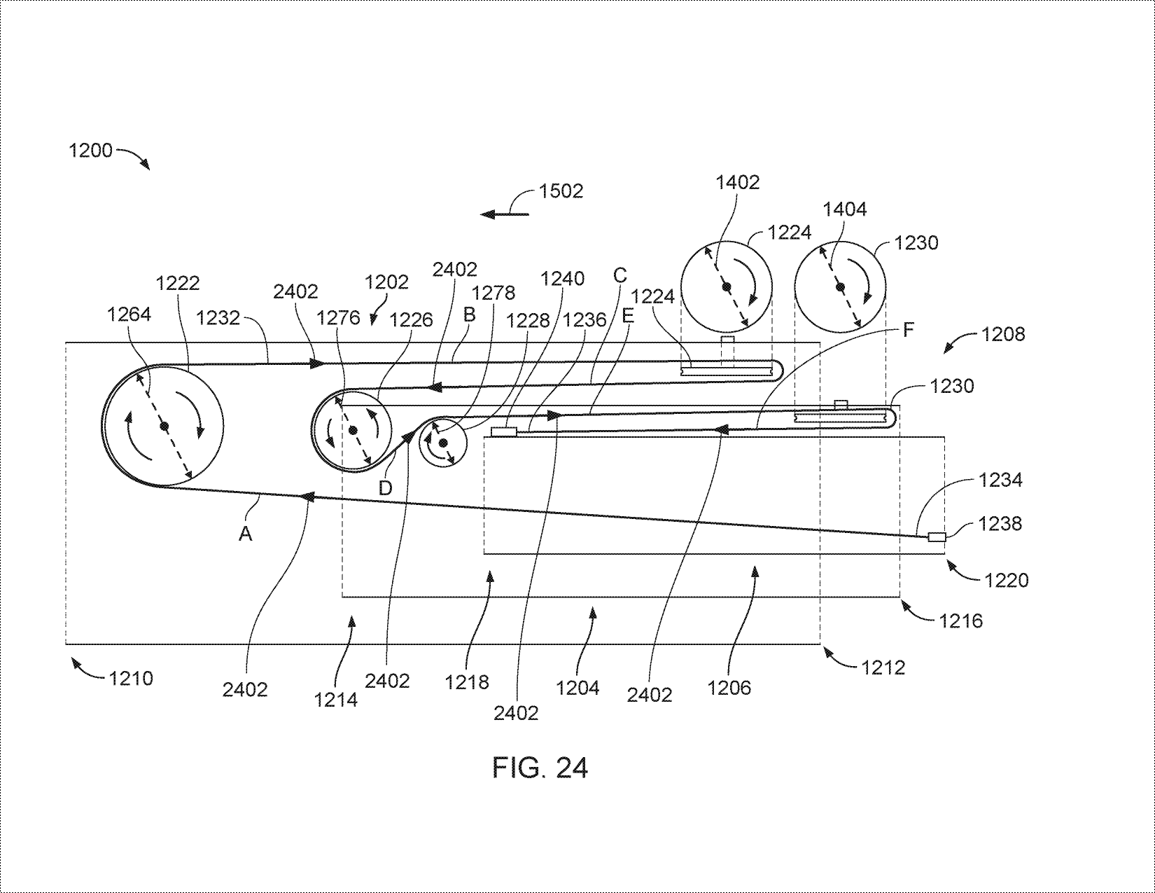

The drive mechanism 1602 is coupled between the base beam 1202 and the intermediate beam 1204. The base beam 1202 is fixed to the refuse collection vehicle 100. When the drive mechanism 1602 retracts in the second direction 1502 distally, the drive mechanism 1602 imparts a force in the second direction 1502 to the intermediate beam 1204. The intermediate beam 1204 retracts in the second direction 1502. The first tether 1232 is in tension in the direction of arrows 2402, shown in FIG. 24, along the first pathway and pulls the grabber beam 1206 in the second direction 1502 to move the arm assembly 1200 from the extended position 1302 to the retracted position 1208. As the first tether 1232 moves, the third wheel 126 rotates counterclockwise and slides along the first tether 1232. The first wheel 1222 and the fourth wheel 1228 rotate in the clockwise direction. The second wheel 1224 and the fifth wheel 1230, when viewed from the top, rotate in the clockwise direction. The length of segment “G” decreases to a minimum length as the proximal end 1218 of the grabber beam 1206 moves from the extended position 1302 to the retracted position 1208. The length of segment “B” is constant since the both the first wheel 1222 and the second wheel 1224 are mounted on the base beam 1202. The length of segment “C” increases to a maximum length as the proximal end 1214 of the intermediate beam 1204 moves toward the proximal end 1210 of the base beam 1202. A length of segment “D” is constant since both the third wheel 1226 and the fourth wheel 1228 are mounted on the intermediate beam 1204. The length of segment “E” is constant since the fourth wheel 1228 and the fifth wheel 1230 are both mounted on the intermediate beam 1204. The length of segment “F” increases to a maximum as the tension in the second direction 1502 pulls the grabber beam 1206 in the second direction 1502.

Referring to FIGS. 12-13, the arm assembly 1200 has another set of multiple wheels (another first wheel 1242, another second wheel 1244, another third wheel 1246, another fourth wheel 1248, and another fifth wheel 1250) and a second tether 1252 which mirror the first set of multiple wheels (the first wheel 1222, the second wheel 1224, the third wheel 1226, the fourth wheel 1228, and the fifth wheel 1230) and first tether 1232. The first wheel 1242, the second wheel 1244, the third wheel 1246, the fourth wheel 1248, and the fifth wheel 1250) and the second tether 1252 provide a built-in safety factor and redundancy for operating the arm assembly 1200. Both sets of wheels and tethers are each separately capable of extending and retracting the arm assembly 1200. Therefore, all corresponding wheels serve the same purpose and are of approximately the same size. This arrangement splits the load between two individual pathways, thereby halving the force on each tether 1232, 1252. Additionally, if one of the tethers 1232 or 1252 were to snap, the intermediate beam 1204 and the grabber beam 1206 are still head in place and can still be operated when desired. If this were not the case, if/when a tether 1232, 1252 failed, the intermediate beam 1204 and the grabber beam 1206 could extend uncontrollably.

The second set of wheels, shown in FIGS. 12-13, include the first wheel 1242, the second wheel 1244, the third wheel 1246, the fourth wheel 1248, and the fifth wheel 1250. The second tether 1252 extends between the first wheel 1242, the second wheel 1244, the third wheel 1246, the fourth wheel 1248, and the fifth wheel 1250.

The second tether 1252 has a first end 1254 and a second end 1256. The first end 1254 of the second tether 1252 terminates on the grabber beam 1206 at a third location 1258 and the second end 1256 terminates on the grabber beam 1206 at a fourth location 1260. The second tether 1252 is supported by the first wheel 1242; the second wheel 1244, the third wheel 1246, the fourth wheel 1248, and the fifth wheel 1250. The first end 1254 of the second tether 1252 terminates on the grabber beam 1206 at the third location 1258 on an inner surface 1282 of the grabber beam 1206 and the second end 1256 of the second tether 1252 terminates on the grabber beam 1206 at the fourth location 1260 on the outer surface 1284 of the grabber beam 1206.

The second tether 1252 extends from the third location 1258 on the grabber beam 1206 between the first wheel 1242, the second wheel 1244, the third wheel 1246, the fourth retraction wheel 1248, and the fifth wheel 1250 to the fourth location 1260 on the grabber beam 1206. The second tether 1252 is supported in the arm assembly 1200 by the first wheel 1242, the second wheel 1244, the third wheel 1246, the fourth retraction wheel 1248, and the fifth wheel 1250.

The first wheel 1242 is mounted in the base beam 1202 vertically below and offset horizontally from the first wheel 1222. The first wheel 1242 is coupled to the inner surface 1262 of the base beam 1202. The first wheel 1242 is mounted in the proximal end 1210 of the base beam 1202. Referring to FIGS. 19-20, the arm assembly 1200 has a shaft 1908 and bearings 1910. The bearings 1910 are mounted to the vertical walls 1906 of the base beam 1202 on the inner surface 1262. The shaft 1908 extends into the bearings 1910. The first wheel 1242 is coupled to the shaft 1908. The first wheel 1242 and the shaft 1908 are free to rotate about an axis of the shaft 1908. The bearings 1910 allow the shaft 1908 and the first wheel 1242 to rotate. The first wheel 1242 is oriented vertically in the arm assembly 1200 (i.e., vertical to the ground on which the refuse collection vehicle 100 rests).

The first wheel 1242 receives the second tether 1252. The first wheel 1242 rotates responsive to the second tether 1252 moving relative to the first wheel 1242. The first wheel 1242 has a groove. The groove of the first wheel 1242 is sized to receive the second tether 1252. The second tether 1252 rides in the groove of the first wheel 1242.

The first wheel 1242 has a diameter 1286. In this implementation, the diameter 1286 of the first wheel 1242 is between four and six inches, however, in other implementations, the first wheel 1242 can have any suitable diameter 1286.

The second wheel 1244 is mounted to the inner surface 1262 of the base beam 1202 at the distal end 1212 of the base beam 1202 on the opposite side of the base beam 1202 from the second wheel 1224 on a bottom wall 1290 of the base beam 1202. The second wheel 1244 is oriented horizontally in the arm assembly 1200. The second wheel 1244 rests in the space between the base beam 1202 and the intermediate beam 1204. The arm assembly 1200 includes a fastener 1288 to couple the second wheel 1244 to the base beam 1202. The fastener 1288 includes a bolt, multiple washers, a ball bearing, and an internally threaded bearing insert. The internally threaded insert fits inside the ball bearing. The bolt extends through the bottom wall 1290 of the base beam 1202. The second wheel 1244 rotates about the shaft of the bolt, is held in place by the internally threaded insert, and is supported by the ball bearing. The second wheel 1244 is oriented orthogonally to the first wheel 1242.

The second wheel 1244 receives the second tether 1252. The second wheel 1244 rotates responsive to the second tether 1252 moving relative to the second wheel 1244. The second wheel 1244 has a groove. The groove of the second wheel 1244 is sized to receive the second tether 1252. The second tether 1252 rides in the groove of the second wheel 1244.

The second wheel 1244 has a diameter 1504 (shown in FIG. 15). In this implementation, the diameter 1504 of the second wheel 1244 is at least four inches, however, the second wheel 1244 may have any suitable diameter 1504.

The third wheel 1246 is coupled to the proximal end 1214 of the intermediate beam 1204 and vertically and horizontally offset from the diameter 1276 The third wheel 1246 is horizontally offset from the first wheel 1242. The third wheel 1246 at least partially extends from the proximal end 1214 of the intermediate beam 1204 into the base beam 1202. At least a portion of the third wheel 1246 extends below a bottom wall 1292 of the intermediate beam 1204. In some cases, a portion of the proximal end 1214 of the intermediate beam 1204 is cut out to allow the third wheel 1246 to extend below the bottom wall 1292 of the intermediate beam 1204. The third wheel 1246 is mounted to a bearing. The bearing is mounted to the inner surface 1272 of the vertical wall 1274 of intermediate beam 1204. The bearing is positioned on the inner surface 1272 of the intermediate beam 1204 to extend the third wheel 1246 from the proximal end 1214 of the intermediate beam 1204 into base beam 1202. The third wheel 1246 is oriented vertically in the arm assembly 1200. The third wheel 1246 rotates relative to the bearing.

The third wheel 1246 receives the second tether 1252. The third wheel 1246 rotates responsive to the second tether 1252 moving relative to the third wheel 1246. The third wheel 1246 has a groove. The groove of the third wheel 1246 is sized to receive the second tether 1252. The second tether 1252 rides in the groove of the third wheel 1246.

The third wheel 1246 has a diameter 1506 (shown in FIG. 15). In this implementation, the diameter 1506 of the third wheel 1246 is between four and six inches. However, in other implementations, the third wheel 1246 can have any acceptable diameter.

The fourth wheel 1248 is coupled at the proximal end 1214 of the intermediate beam 1204, inward (i.e., in the distal direction) from the third wheel 1246, in line with the third wheel 1246. The fourth wheel 1248 is offset from the third wheel 1246 along the length of the intermediate beam 1204 extending between the proximal end 1214 and the distal end 1216 of the intermediate beam 1204. The fourth wheel 1248 is mounted to a bearing. The bearing is mounted to the inner surface 1272 of the vertical wall 1274 of intermediate beam 1204 on the opposite side wall from the fourth wheel 1228. The bearing is positioned on the inner surface 1272. The fourth wheel 1248 is oriented vertically in the arm assembly 1200. The fourth wheel 1248 rotates relative to the bearing.

The fourth wheel 1248 receives the second tether 1252. The fourth wheel 1248 rotates responsive to the second tether 1252 moving relative to the fourth wheel 1248. The fourth wheel 1248 has a groove. The groove of the fourth wheel 1248 is sized to receive the second tether 1252. The second tether 1252 rides in the groove of the fourth wheel 1248.

The fourth wheel 1248 has a diameter 1508 (shown in FIG. 15). The diameter 1508 of the fourth wheel 1248 is between two and three inches. In this implementation, the diameter 1508 of the fourth wheel 1248 is less than the diameter 1508 of the third wheel 1246. However, in other implementations, the fourth wheel 1248 may have any suitable diameter 1508.

A center of the fourth wheel 1248 is offset vertically from a center of the third wheel 1246. One or both of the difference in diameters between the third wheel 1246 and the fourth wheel 1248 and the vertical offset between the centers of the third wheel 1246 and the fourth wheel 1248 change a vertical height of the second tether 1252 in the arm assembly 1200. The third wheel 1246 and the third wheel 1246 alter the height of the second tether 1252 to align the second tether 1252 to be positioned between the intermediate beam 1204 and the grabber beam 1206.

The fifth wheel 1250 is mounted at the distal end 1216 of the intermediate beam 1204. The fifth wheel 1250 is oriented horizontally in the arm assembly 1200. The fifth wheel 1250 is mounted to the inner surface 1272 of the bottom wall 1292 of the intermediate beam 1204 at the distal end 1216 of the intermediate beam 1204. The fifth wheel 1250 rests in the space between the intermediate beam 1204 and the grabber beam 1206. The arm assembly 1200 includes a fastener 1294 to couple the fifth wheel 1250 to the intermediate beam 1204. The fastener 1294 includes a bolt, multiple washers, a ball bearing, and an internally threaded bearing insert. The internally threaded insert fits inside the ball bearing. The bolt extends through the bottom wall 1292 of the intermediate beam 1204. The fifth wheel 1250 rotates about the shaft of the bolt, is held in place by the internally threaded insert, and is supported by the ball bearing. The fifth wheel 1250 is oriented orthogonally to the fourth wheel 1248.

The fifth wheel 1250 receives the second tether 1252. The fifth wheel 1250 rotates responsive to the second tether 1252 moving relative to the fifth wheel 1250. The fifth wheel 1250 has a groove. The groove of the fifth wheel 1250 is sized to receive the second tether 1252. The second tether 1252 rides in the groove of the fifth wheel 1250.

The fifth wheel 1250 has a diameter 1510 (shown in FIG. 15). The diameter 1510 of the fifth wheel 1250 is between two and three inches. The diameter 1510 of the fifth wheel 1250 can be approximately half of the diameter 1286 of the first wheel 1242. However, in other implementations, the fifth wheel 1250 may have any suitable diameter 1510.

The diameters of the first wheel 1242, the second wheel 1244, the third wheel 1246, the fourth wheel 1248, and the fifth wheel 1250 can be selected to increase the mechanical advantage or increase the speed of operation of the arm assembly 1200.

The first end 1254 of the second tether 1252 terminates at the third location 1258. The third location 1258 is on the inner surface 1282 of the grabber beam 1206. The second end 1256 of the second tether 1252 terminates at the fourth location 1260 on the outer surface 1284 of the grabber beam 1206. The length of the second tether 1252, and thus the length of a second pathway, is static. That is, during operation of the arm assembly 1200, the second tether 1252 does not extend or retract appreciably. The second tether 1252 does not deform linearly.

The second tether 1252 is positioned along a second pathway. The second pathway of the arm assembly 1200 begins at the third location 1258 on the inner surface 1282 of the grabber beam 1206. The second pathway extends from the third location 1258 on the inner surface 1282 of the grabber beam 1206, out the proximal end 1218 of the grabber beam 1206, out the proximal end 1214 of the intermediate beam 1204, to the first wheel 1242. The second pathway continues around the first wheel 1242 vertically changed the height of the second tether 1252. The first pathway changes direction between the proximal direction to the distal direction around the base beam 1202, the intermediate beam 1204, and the grabber beam 1206. The second pathway continues from the first wheel 1242 to the distal end 1212 of the base beam 1202 between the intermediate beam 1204 and the base beam 1202 to the second wheel 1244. The second pathway continues around the second wheel 1244 horizontally, reversing direction toward the proximal end 1214 of the intermediate beam 1204 to the third wheel 1246. The second pathway extends around the third wheel 1246 to the fourth wheel 1248 and about the fourth wheel 1248 to change a vertical height of the second tether 1252 to align the second tether 1252 to pass toward the distal end 1216 of the intermediate beam 1204 between the intermediate beam 1204 and the grabber beam 1206 to the fifth wheel 1250. The second pathway continues around the fifth wheel 1250 horizontally, reversing direction toward the proximal end 1218 of the grabber beam 1206 to the second location 1240 on the grabber beam 1206 on the outer surface 1284 of the grabber beam 1206. The second tether 1252 is disposed along the second pathway.

Referring to FIG. 15, the second pathway defines segments of the second tether 1252 between each component. Segment “G” of the second tether 1252 extends between the third location 1258 on the inner surface 1282 of the grabber beam 1206 and the first wheel 1242. Segment “H” extends from the first wheel 1242 to the second wheel 1244. Segment “I” extends from the second wheel 1244 to the third wheel 1246. Segment “J” extends from the third wheel 1246 to the fourth wheel 1248. Segment “K’’ extends from the fourth wheel 1248 to the fifth wheel 1250. Segment “L” extends from the fifth wheel 1250 to the fourth location 1260 on the outer surface 1284 of the grabber beam 1206.

Referring to FIGS. 12-13, and 15, operation of the drive mechanism 1602 (an actuator) in the second direction 1502 retracts the intermediate beam 1204 relative to the base beam 1202. Since the length of the second tether 1252 is fixed, the first end 1254 and the second end 1256 are fixed to the grabber beam 1206, and the second tether 1252 extends along the second pathway, the second tether 1252 transfers a second force from the intermediate beam 1204 to the grabber beam 1206 by moving the second tether 1252 along the second pathway and rotating the first wheel 1242, the second wheel 1244, the third wheel 1246, the fourth wheel 1248, and the fifth wheel 1250. Responsive to moving the second tether 1252 along the second pathway, the grabber beam 1206 moves in the second direction 1502, sliding relative to the intermediate beam 1204, from the extended position 1302 to the retracted position 1208.

The drive mechanism 1602 is coupled between the base beam 1202 and the intermediate beam 1204. The base beam 1202 is fixed to the refuse collection vehicle 100. When the drive mechanism 1602 retracts in the second direction 1502 distally, the drive mechanism 1602 imparts a force in the second direction 1502 to the intermediate beam 1204. The intermediate beam 1204 extends in the second direction 1502. The second tether 1252 is in tension in the direction of arrows 1512 along the second pathway and pulls the grabber beam 1206 in the second direction 1502 to move the arm assembly 1200 from the extended position 1302 to the retracted position 1208. As the second tether 1252 moves, the third wheel 1246 rotates clockwise and slides along the second tether 1252. The first wheel 1242 and the fourth wheel 1248 rotate in the counterclockwise direction. The second wheel 1244 and the fifth wheel 1250, when viewed from the top, rotate in the counterclockwise direction. A length of segment “G” decreases to a minimum length as the proximal end 1218 of the grabber beam 1206 moves from the extended position 1302 to the retracted position 1208. A length of segment “H” is constant since the both the first wheel 1242 and the second wheel 1244 are mounted on the base beam 1202. A length of segment “I” increases a maximum length as the proximal end 1214 of the intermediate beam 1204 moves toward the proximal end 1210 of the base beam 1202. A length of segment “J” is constant since both the third wheel 1246 and the fourth wheel 1248 are mounted on the intermediate beam 1204. A length of segment “J” is constant since the fourth wheel 1248 and the fifth wheel 1250 are both mounted on the intermediate beam 1204. A length of segment “L” increases to a maximum as the tension in the second direction 1502 pulls the grabber beam 1206 in the second direction 1502.

In this implementation, the arm assembly 1200 is sized so no drive mechanism 1602 is contained within the arm assembly 1200. That is, each of the base beam 1202, the intermediate beam 1204, and the grabber beam 1206 are too small for an actuator to be inside the arm assembly 1200. However, in other implementations, at least the base beam 1202 and the intermediate beam 1204 can be sized to allow placement of the drive mechanism 1602 within the inner volume of the arm assembly 1200.

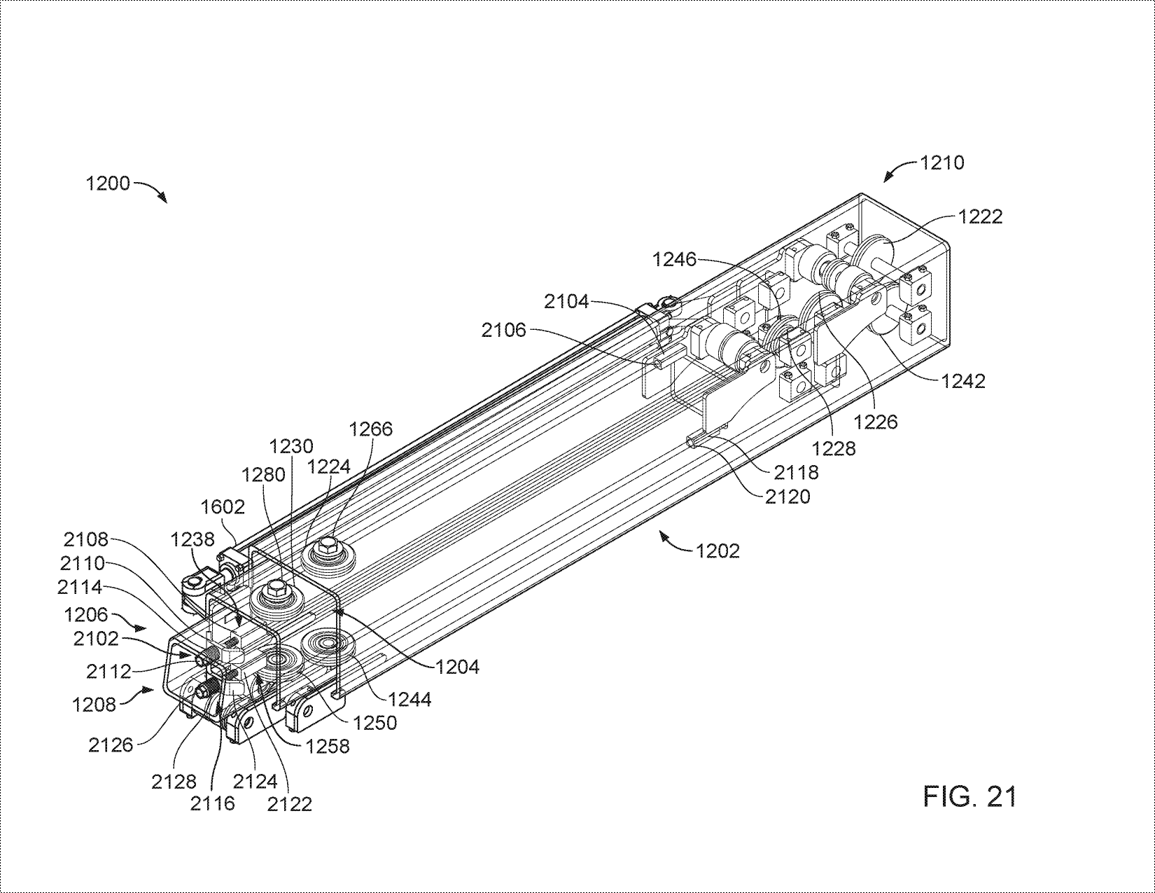

Referring to FIG. 21. the arm assembly 1200 includes tensioners for the first tether 1232 and the second tether 1252 to maintain a tension force within a threshold range. The arm assembly 1200 has a first tensioner 2102. The first tensioner 2102 can increase, decrease, or hold the tension in the first tether 1232. The first tensioner 2102 is positioned at the first location 1238 and coupled to the inner surface 1282 of the grabber beam 1206. The first end 1234 of the first tether 1232 is coupled to the first tensioner 2102. The second end 1236 of the first tether 1232 is coupled to a block 2104. The block 2104 is fixed to the outer surface 1284 of the grabber beam 1206 at the second location 1240. The block 2104 is a tubular structure with a circular void 2106 to receive and couple to the second end 1236 of the first tether 1232. The first tensioner 2102 has a block 2108, a frame 2110, a bolt 2112, and a spring 2114. The block 2108 is coupled to the first tether 1232 and is movable to increase or decrease the tension in the first tether 1232. The frame 2110 is fixed to the inner surface 1282 of the grabber beam 1206 across the vertical walls of the grabber beam 1206. The frame 2110 has a threaded void. The bolt 2112 extends through the threaded void and is coupled to the block 2108. The spring 2114 is disposed between the bolt 2112 and the frame 2110. The spring 2114 forces the distal end of the bolt 2112 toward the distal end 1220 of the grabber beam 1206. The end of the bolt 2112 is exposed to the opening at the distal end 1220 of the grabber beam 1206 and is accessible by the operator to couple a tool to rotate the bolt 2112 to move in the longitudinal axis of the arm assembly 1200, causing the block 2108 to move, and increasing or decreasing the tension in the first tether 1232 based on the direction of rotation of the bolt 2112.

The arm assembly 1200 has a second tensioner 2116. The second tensioner 2116 is positioned at the third location 1258 and coupled to the inner surface 1282 of the grabber beam 1206. The first end 1254 of the second tether 1252 is coupled to the second tensioner 2116. The second end 1256 of the second tether 1252 is coupled to a block 2118. The block 2118 is fixed to the outer surface 1284 of the grabber beam 1206 at the fourth location 1260. The block 2118 is a tubular structure with a circular void 2120 to receive and couple to the second end 1256 of the second tether 1252. The second tensioner 2116 has a block 2122, a frame 2124, a bolt 2126, and a spring 2128. The block 2118 is coupled to the second tether 1252 and is movable to increase or decrease the tension in the second tether 1252. The frame 2124 is fixed to the inner surface 1282 of the grabber beam 1206 across the vertical walls of the grabber beam 1206. The frame 2124 has a threaded void. The bolt 2126 extends through the threaded void and is coupled to the block 2118. The spring 2128 is disposed between the bolt 2126 and the frame 2124. The spring 2128 forces the distal end of the bolt 2126 toward the distal end 1220 of the grabber beam 1206. The end of the bolt 2126 is exposed to the opening at the distal end 1220 of the grabber beam 1206 and is accessible by the operator to couple a tool to rotate the bolt 2126 to move in the longitudinal axis of the arm assembly 1200, causing the block 2118 to move, and increasing or decreasing the tension in the retraction tether 1252 based on the direction of rotation of the bolt 2126.

Referring to FIGS. 12-13 and 16-21, the arm assembly 1200 has a first external roller assembly 1296, a second external roller assembly 1298, a first internal roller assembly 1299, and a second internal roller assembly 1297. The second external roller assembly 1298 is coupled externally and internally to the base beam 1202 about the distal end 1212 of the base beam 1202 and extends distally from the base beam 1202. The second external roller assembly 1298 directly supports the intermediate beam 1204, and indirectly supports the grabber beam 1206. The second external roller assembly 1298 allows the intermediate beam 1204 to slide relative to the base beam 1202. The first external roller assembly 1296 is coupled internally and externally to the intermediate beam 1204 at the distal end 1216 of the intermediate beam 1204 and extends distally from the intermediate beam 1204. The first external roller assembly 1296 directly supports the grabber beam 1206. The first external roller assembly 1296 allows the grabber beam 1206 to slide relative to the intermediate beam 1204. The first internal roller assembly 1299 is coupled to the proximal end 1214 of the intermediate beam 1204 and extends in the proximal direction from the intermediate beam 1204. The first internal roller assembly 1299 supports the intermediate beam 1204 within the base beam 1202. The second internal roller assembly 1297 is coupled to the proximal end 1218 of the grabber beam 1206 and extends in the proximal direction from the grabber beam 1206. The second internal roller assembly 1297 supports the grabber beam 1206 within the intermediate beam 1204. The number of rollers at each location can vary based on the calculated or actual load at any specific location. Any suitable number of rollers may be used.

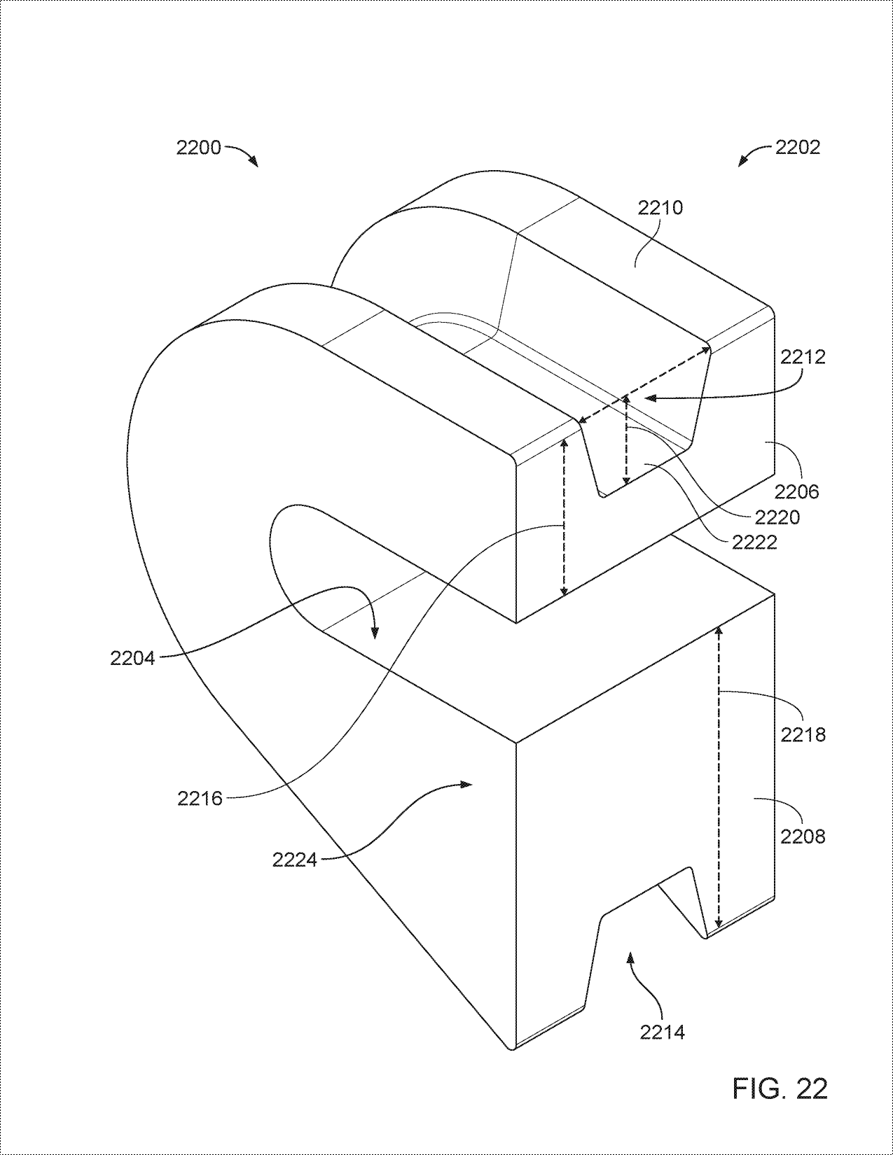

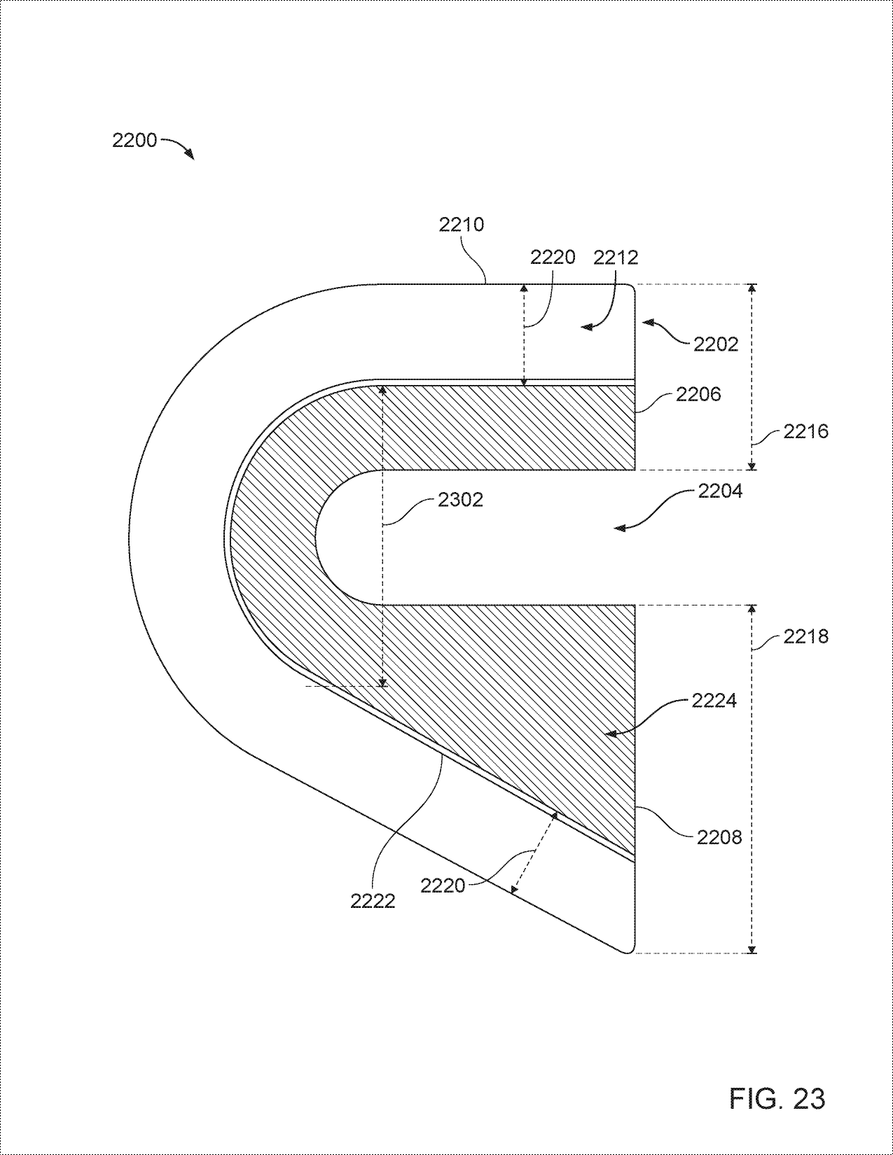

FIGS. 22-23 show another guide block 2200 that can be used in conjunction or in the place of either of the extension block 526 and the retraction block 528 for the arm assembly 202. The block 2200 is shaped to align the extension tether 242 toward the respective location and improve smooth operation and sliding of the extension tether 242 relative to the guide block 2200.

The block 2200 has a body 2202 that is generally arcuate shaped to fit about the distal end 252 of the grabber beam 234. The body 2202 has a void 2204 sized to receive the distal end 252 of the grabber beam 234 and mate with the inner surface 514 of the grabber beam 234 and the outer surface 530 of the grabber beam 234. The void 2204 extends from a plane between a first surface 2206 and a second surface 2208. The body 2202 has an outer surface 2210. The outer surface 2210 is arcuate.

The block 2200 has a channel 2212 extending from outer surface 2210 into the body 2202 toward the void 2204. The channel 2212 extends from the first surface 2206 to the second surface 2208. The channel 2212 receives the extension tether 242 and allows the extension tether 242 slide about the distal end 252 of the grabber beam 234. The channel 2212 has a generally U-shaped profile with a ramped portion 2224. The ramped portion 2224 extends away from the void 2204 to smoothy guide and direct the extension tether 242 in the desired direction.

The channel 2212 has a trapezoidal cross-section 2214. However, in other implementations, the channel 2212 can have any suitable shaped cross-section.

Referring to FIG. 23, the channel 2212 has an inner diameter 2302. In this implementation, the inner diameter 2302 of the channel 2212 can be between 0.7 and 0.9 inches. However, in other implementations, the channel 2212 can have any suitable inner diameter 2302.

The first surface 2206 has a height 2216. The second surface 2208 has a height 2218. In this implementation, the height 2216 of the first surface 2206 is greater than the height 2218 of the second surface 2208. However, in other implementations, the height 2216 of the first surface 2206 can be less than or equal to the height 2218 of the second surface 2208.

The channel 2212 has a depth 2220. The depth 2220 of the channel 2212 extends from the outer surface 2210 of the body 2202 to a bottom surface 2222 of the channel 2212. In this implementation, the depth 2220 of the channel 2212 is generally the same. However, in other implementations, the depth 2220 of the channel can increase or decrease from the first surface 2206 to the second surface 2208. The depth 2220 of the channel 2212 can be less than, equal to, or greater than a diameter of the extension tether 242.

In this implementation, only one side of the channel 2212 includes the ramped portion 2224. In other implementations, the other side of body 2202 can include the ramped portion 2224. In other implementations, the block 2200 can include two ramped portions 2224, with one extending to each of the first surface 2206 and the second surface 2208.

In this implementation, the ramped portion 2224 is inclined. However, in other implementations, the ramped portion 2224 can be a decline towards the void 2204.

In various implementations described above, the horizontal positioning system includes structural members having a rectangular cross section. For example, in certain implementations, the movable sections are seam-welded rectangular tubes. In other implementations, a horizontal positioning system includes structural members with other cross sections. Examples include circular tubes, ovate tubes, triangular tubes, U-shaped tubes, I-beams, and/or H-beams.

In various implementations described above, refuse loading mechanisms have been described for use on a residential automated side loader vehicle. Implementations can, however, be employed with respect to any suitable type of RCV, with any suitable type of body and/or hopper variants. For example, the RCV can be residential front loader. As another example, the RCV can be a commercial front loader (e.g., for dumpster type containers). A front loader can be provided with or without an intermediate collection device. In some implementations, a refuse lift arm as described herein automatically loads an intermediate collection device, which is then operated to transfer refuse in the intermediate collection device to another storage container on the refuse collection vehicle.

As used herein, a “drive unit” includes any device, mechanism, or system that imparts force to mechanically drive one or more components. Examples of a drive unit include a hydraulic motor, a linear actuator, an electric motor, or an engine.

As used herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As used herein, the term “approximately” refers to a condition or parameter which can have a value or threshold value generally within acceptable engineering, machining, measurement, or manufacturing tolerances. For example, the parameter value or threshold value can be considered approximately met when the value is within 5% of the actual parameter value or threshold value. For example, the parameter value can be considered to be equal to the threshold value when the parameter value is within 5% of the threshold value. However, different approximations for different parameter values or threshold values may be used in different embodiments.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

A number of implementations have been described. Nevertheless, it will be understood that various modifications may be made without departing from the spirit and scope of the disclosure. For example, while certain of the above-described implementations employ various timing belts and pulleys, other types of flexible tethers, such as chains, bands, cables, etc. are also contemplated within the scope of this disclosure. Accordingly, other implementations are within the scope of the following claims.

1. A refuse collection vehicle comprising:
a vehicle chassis;
a refuse collection body coupled to the vehicle chassis; and
an arm assembly coupled to the vehicle chassis and comprising:
a grabber; and
an arm coupled to the grabber and comprising:
a base beam;
an intermediate beam within the base beam;
a grabber beam within the intermediate beam;
an actuator coupled to the intermediate beam;
an extension wheel coupled to an outer surface of the intermediate beam;
an extension tether supported by the extension wheel and comprising a first end and a second end, the first end coupled to an inner surface of the grabber beam, the second end coupled to an outer surface of the base beam;
a retraction wheel coupled to the inner surface of the intermediate beam; and
a retraction tether supported by the retraction wheel and comprising a first end and a second end, the first end coupled to the inner surface of the grabber beam, the second end coupled to the outer surface of the base beam.

2. The refuse collection vehicle of claim 1, wherein:
operation of the actuator in a first direction extends the intermediate beam relative to the base beam, the extension tether transferring a first force from the intermediate beam to the grabber beam, rotating the extension wheel and thereby moving the grabber beam in the first direction, moving the grabber from a retracted position to an extended position; and
operation of the actuator in a second direction opposite the first direction retracts the intermediate beam relative to the base beam, the retraction tether transferring a second force from the intermediate beam to the grabber beam, rotating the retraction wheel and thereby moving the grabber beam in the second direction, moving the grabber from the extended position to the retracted position.

3. The refuse collection vehicle of claim 1, wherein the actuator is a single hydraulic cylinder.

4. A refuse collection vehicle comprising:
a vehicle chassis;
a refuse collection body coupled to the vehicle chassis; and
an arm assembly coupled to the vehicle chassis and comprising:
a grabber; and
an arm coupled to the grabber and comprising:
a base beam;
an intermediate beam within the base beam;
a grabber beam within the intermediate beam;
an actuator coupled to the intermediate beam;
a first set of wheels;
a first tether supported by the first set of wheels and comprising a first end and a second end, the first end terminating on the grabber beam at a first location, the second end terminating on the grabber beam at a second location;
a second set of wheels; and
a second tether supported by the second set of wheels and comprising a first end and a second end, the first end terminating on the grabber beam at a third location, the second end terminating on the grabber beam at a fourth location.

5. The refuse collection vehicle of claim 4, wherein the first set of wheels and the second set of wheels are mounted within an internal volume of the arm assembly.

6. The refuse collection vehicle of claim 4, wherein:
operation of the actuator in a first direction extends the intermediate beam relative to the base beam, the first and second tethers transferring a first force from the intermediate beam to the grabber beam, rotating the first and second set of wheels and thereby moving the grabber beam in the first direction, moving the grabber from a retracted position to an extended position; and
operation of the actuator in a second direction opposite the first direction retracts the intermediate beam relative to the base beam, the first and second tethers transferring a second force from the intermediate beam to the grabber beam, rotating the first and second set of wheels and thereby moving the grabber beam in the second direction, moving the grabber from the extended position to the retracted position.

7. The refuse collection vehicle of claim 4, wherein:
the first end of the first tether terminates at the first location on an inner surface of the grabber beam and the second end of the first tether terminates at the second location on an outer surface of the grabber beam; and
the first end of the second tether terminates at the third location on the inner surface of the grabber beam and the second end of the second tether terminates at the fourth location on the outer surface of the grabber beam.

8. The refuse collection vehicle of claim 4, wherein:
the first set of wheels comprises:
a first wheel coupled to an inner surface of the base beam, the first wheel coupled to a proximal end of the base beam, the first wheel oriented vertically in the arm;
a second wheel coupled to the inner surface of the base beam, the second wheel coupled to a distal end of the base beam, the second wheel oriented horizontally in the arm;
a third wheel coupled to a proximal end of the intermediate beam, the third wheel oriented vertically in the arm;
a fourth wheel coupled at the proximal end of the intermediate beam, the fourth wheel oriented vertically in the arm; and
a fifth wheel coupled to a distal end of the intermediate beam, the fifth wheel oriented horizontally in the arm; and
the second set of wheels comprises:
a first wheel coupled to an inner surface of the base beam, the first wheel coupled to the distal end of the base beam, the first wheel oriented vertically in the arm;
a second wheel coupled to the inner surface of the base beam, the second wheel coupled to the distal end of the base beam, the second wheel oriented horizontally in the arm;
a third wheel coupled to the proximal end of the intermediate beam, the third wheel oriented vertically in the arm;
a fourth wheel coupled at the proximal end of the intermediate beam, the fourth wheel oriented vertically in the arm; and
a fifth wheel coupled to the distal end of the intermediate beam, the fifth wheel oriented horizontally in the arm.

9. The refuse collection vehicle of claim 8, further comprising:
a first pathway extending from the first location on an inner surface of the grabber beam, out a proximal end of the grabber beam, out a proximal end of the intermediate beam, to the first wheel of the first set of wheels, and around the first wheel of the first set of wheels between the base beam and the intermediate beam toward the distal end of the base beam to the second wheel of the first set of wheels, around the second wheel of the first set of wheels reversing direction toward the proximal end of the intermediate beam to the third wheel of the first set of wheels, around the third wheel of the first set of wheels to the fourth wheel of the first set of wheels, about the fourth wheel of the first set of wheels toward the distal end of the intermediate beam, in between the intermediate beam and the grabber beam to the fifth wheel of the first set of wheels, around the fifth wheel of the first set of wheels, reversing direction toward the proximal end of the grabber beam to the second location on the grabber beam, the first tether disposed along the first pathway; and
a second pathway extending from the third location on the inner surface of the grabber beam, out the proximal end of the grabber beam, through the intermediate beam, out the proximal end of the intermediate beam, to the first wheel of the second set of wheels, around the first wheel of the second set of wheels reversing direction toward the distal end of the base beam, between the intermediate beam and the base beam to the second wheel of the second set of wheels, around the second wheel of the second set of wheels reversing direction toward the proximal end of the intermediate beam to the third wheel of the second set of wheels, around the third wheel of the second set of wheels to the fourth wheel of the second set of wheels, about the fourth wheel of the second set of wheels toward the distal end of the intermediate beam, in between the intermediate beam and the grabber beam to the fifth wheel of the second set of wheels, around the fifth wheel of the second set of wheels, reversing direction toward the proximal end of the grabber beam to the fourth location on the grabber beam, the second tether disposed along the second pathway.

10. The refuse collection vehicle of claim 8, wherein the fourth wheel of the first set of wheels and the fourth wheel of the second set of wheels alters a height of the respective tether.

11. The refuse collection vehicle of claim 10, wherein the height of the respective tether is altered in a vertical direction.

12. The refuse collection vehicle of claim 8, wherein a diameter of each of the fourth wheel of the first set of wheels and the fourth wheel of the second set of wheels is less than a diameter of each of the third wheel of the first set of wheels and the third wheel of the second set of wheels, respectively.

13. The refuse collection vehicle of claim 8, wherein a center of each of the fourth wheel of the first set of wheels and the fourth wheel of the second set of wheels is offset vertically from a center of each of the third wheel of the first set of wheels and the third wheel of the second set of wheels.

14. The refuse collection vehicle of claim 4, wherein the actuator is a single hydraulic cylinder.

15. The refuse collection vehicle of claim 14, wherein the actuator is positioned outside an internal volume of the arm assembly.

16. The refuse collection vehicle of claim 4, further comprising a first tensioner positioned at the first location and a second tensioner positioned at the third location, wherein first ends of the first tether and the second tether coupled to the first tensioner and the second tensioner, respectively.

17. The refuse collection vehicle of claim 16, wherein the first tensioner and the second tensioner each comprise:
a block coupled to the respective tether;
a frame;
a bolt extended through the frame to the block; and
a spring positioned between the bolt and the frame.

18. The refuse collection vehicle of claim 4, further comprising:
a first roller assembly mounted to a proximal end of the intermediate beam and extending internal to the arm from the intermediate beam into the base beam;
a second roller assembly mounted to the proximal end of the grabber beam and extending internal to the arm from the grabber beam into the intermediate beam;
a third roller assembly mounted to a distal end of the base beam and extending external to the arm from the base beam to contact the intermediate beam; and
a fourth roller assembly mounted to the distal end of the intermediate beam and extending external to the arm from the intermediate beam to contact the grabber beam.

19. The refuse collection vehicle of claim 4, wherein the intermediate beam and the grabber beam slide relative to the base beam to move the grabber between an extended position and a retracted position.

20. A refuse collection vehicle comprising:
a vehicle chassis;
a refuse collection body coupled to the vehicle chassis; and
an arm assembly coupled to the vehicle chassis and comprising:
a grabber; and
an arm coupled to the grabber and comprising:
a base beam;
an intermediate beam within the base beam;
a grabber beam within the intermediate beam;
an actuator coupled to the intermediate beam;
an extension wheel coupled to an outer surface of the intermediate beam;
an extension tether supported by the extension wheel and comprising a first end and a second end, the first end coupled to an inner surface of the grabber beam, the second end coupled to an outer surface of the base beam;
a retraction wheel coupled to the inner surface of the intermediate beam;
a retraction tether supported by the retraction wheel and comprising a first end and a second end, the first end coupled to the inner surface of the grabber beam, the second end coupled to the outer surface of the base beam;
an extension block coupled to a proximal end of the grabber beam, the extension block configured to receive the extension tether;
a retraction block coupled to a distal end of the base beam, the retraction block configured to receive the retraction tether;
a first pathway extending from a first location on the inner surface of the grabber beam, out a proximal end of the grabber beam, between the grabber beam and the intermediate beam, out a distal end of the intermediate beam, and around the extension wheel to a second location on the base beam, the extension tether disposed along the first pathway; and
a second pathway extending from a third location on the inner surface of the grabber beam, out the proximal end of the grabber beam, through the intermediate beam to the retraction wheel, out the proximal end of the intermediate beam, between the intermediate beam and the base beam, out the distal end of the base beam, to a fourth location on the base beam, the retraction tether disposed along the second pathway.
